(19) United States
(12) Patent Application Publication
(10) Pub. No.: US 2026/0156088 A1
(43) Pub. Date: Jun. 4, 2026

(54) PACKET PROCESSING APPARATUS, PACKET COMMUNICATION SYSTEM, PACKET PROCESSING CIRCUIT, AND PACKET PROCESSING METHOD

(71) Applicant: Fujitsu Limited, Kawasaki-shi (JP)

(72) Inventors: Kazuto NISHIMURA, Yokohama (JP); Waki IWATA, Kawasaki (JP)

(73) Assignee: Fujitsu Limited, Kawasaki-shi (JP)

(21) Appl. No.: 19/401,750

(22) Filed: Nov. 26, 2025

(30) Foreign Application Priority Data
Nov. 29, 2024 (JP) 2024-209126

(51) Int. Cl. H04L 49/90; H04L 43/0852

(52) U.S. Cl. CPC H04L 49/9021; H04L 43/0852

(57) ABSTRACT

A packet processing apparatus includes a packet processor that processes a received packet and a buffering storage that performs storage processing on the received packet. The buffering storage includes a plurality of buffers that each stores the received packet, a selector that selects the buffer from which the packet is output, and a switching controller that controls the selector to sequentially switch buffers to be read from the plurality of buffers. The packet processor includes a distribution controller that determines a buffer of a distribution destination based on an insertion delay amount of each flow to which the packet belongs when the packet is received.

### CROSS-REFERENCE TO RELATED APPLICATION

This application is based upon and claims the benefit of priority of the prior Japanese Patent Application No. 2024-209126, filed on November 29, 2024, the entire contents of which are incorporated herein by reference.

### FIELD

The embodiments discussed herein are related to a packet processing apparatus, a packet processing circuit, and a packet processing method.

### BACKGROUND

As a main requirement of 5G (5^{th} Generation Mobile Communication System), for example, concepts of large capacity, low latency, and multiple connection have newly appeared, but importance of these concepts continues to increase in B5G (Beyond 5G) and 6G. In particular, "low latency" is a concept that has not been considered much in the past, and even existing networks are often unable to guarantee "low latency".

Furthermore, even when referring to low-latency applications, the requirements vary greatly. In particular, with the appearance of a new service called URLLC (Ultra-Reliable and Low Latency Communications), there may be new requirements such as jitter removal and delay insertion. Therefore, in order to cope with such URLLC service, a method capable of more actively adjusting the latency is desired.

In the conventional QoS control, priority control such as arbitration of a packet read order in units of priority classes/flows, and rate control such as output rate adjustment are performed.

Patent Literature 1: Japanese Laid-open Patent Publication No. 2015-61126

Patent Literature 2: U.S. Patent No. 7392279

Patent Literature 3: U.S. Patent No. 5872822

However, in conventional QoS control, since it is not possible to intentionally change the packet readout time, for example, to execute delay guarantees or delay insertion such as making it wait 5 msec, delay and jitter are not able to be adjusted.

### SUMMARY

According to an aspect of an embodiment, a packet processing apparatus includes a packet processor that processes a received packet and a buffering storage that performs storage processing on the received packet. The buffering storage includes a plurality of buffers that each stores the received packet, a selector that selects the buffer from which the packet is output, and a switching controller that controls the selector to sequentially switch buffers to be read from the plurality of buffers. The packet processor includes a distribution controller that determines a buffer of a distribution destination based on an insertion delay amount of each flow to which the packet belongs when the packet is received.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram illustrating an example of a packet communication system according to Example 1;

FIG. 2 is an explanatory diagram illustrating an example of a packet processing apparatus;

FIG. 3 is an explanatory diagram illustrating an example of a table configuration of a TS information table;

FIG. 4 is an explanatory diagram illustrating an example of a table configuration of a current TS management unit;

FIG. 5 is an explanatory diagram illustrating an example of a table configuration of a delay information table;

FIG. 6 is an explanatory diagram illustrating an example of a table configuration of a buffer management table;

FIG. 7 is an explanatory diagram illustrating an example of a buffering operation of the packet processing apparatus;

FIG. 8 is a flowchart illustrating an example of a processing operation of the packet processing apparatus related to first reception processing;

FIG. 9 is an explanatory diagram illustrating an example of a packet communication system according to Example 2;

FIG. 10 is an explanatory diagram illustrating an example of a transmission-side packet processing apparatus;

FIG. 11 is an explanatory diagram illustrating an example of a reception-side packet processing apparatus;

FIG. 12 is a flowchart illustrating an example of a processing operation of the reception-side packet processing apparatus related to second reception processing;

FIG. 13 is an explanatory diagram illustrating an example of a reception-side packet processing apparatus according to Example 3;

FIG. 14 is an explanatory diagram illustrating an example of a FIFO range;

FIG. 15 is a flowchart illustrating an example of a processing operation of the reception-side packet processing apparatus related to third reception processing;

FIG. 16 is an explanatory diagram illustrating an example of a packet communication system according to Example 4;

FIG. 17 is an explanatory diagram illustrating an example of a transmission-side packet processing apparatus;

FIG. 18 is an explanatory diagram illustrating an example of a reception-side packet processing apparatus;

FIG. 19 is a sequence diagram illustrating an example of TS synchronization processing;

FIG. 20 is a flowchart illustrating an example of a processing operation of the reception-side packet processing apparatus related to reception-side synchronization processing;

FIG. 21 is a flowchart illustrating an example of a processing operation of the transmission-side packet processing apparatus related to transmission-side synchronization processing;

FIG. 22 is an explanatory diagram illustrating an example of a packet communication system according to Example 5;

FIG. 23 is an explanatory diagram illustrating an example of a transmission-side packet processing apparatus;

FIG. 24 is an explanatory diagram illustrating an example of a table configuration of an SN counter;

FIG. 25 is an explanatory diagram illustrating an example of a reception-side packet processing apparatus;

FIG. 26 is an explanatory diagram illustrating an example of a table configuration of an SN management table;

FIG. 27 is an explanatory diagram illustrating an example of a buffering operation of the reception-side packet processing apparatus;

FIG. 28 is a flowchart illustrating an example of a processing operation of the reception-side packet processing apparatus related to fourth reception processing;

FIG. 29 is a flowchart illustrating an example of a processing operation of the reception-side packet processing apparatus related to the expected SN update processing;

FIG. 30 is an explanatory diagram illustrating an example of a packet communication system according to Comparative Example 1;

FIG. 31A is an explanatory diagram illustrating an example of a buffering state of Comparative Example 1;

FIG. 31B is an explanatory diagram illustrating an example of a buffering state of Comparative Example 1;

FIG. 31C is an explanatory diagram illustrating an example of a buffering state of Comparative Example 1;

FIG. 32 is an explanatory diagram illustrating an example of a packet communication system according to Comparative Example 2;

FIG. 33A is an explanatory diagram illustrating an example of a buffering state of Comparative Example 2;

FIG. 33B is an explanatory diagram illustrating an example of a buffering state of Comparative Example 2; and

FIG. 33C is an explanatory diagram illustrating an example of a buffering state of Comparative Example 2.

### DESCRIPTION OF EMBODIMENTS

Preferred embodiments of the present invention will be explained with reference to accompanying drawings. Note that the disclosed technology is not limited by each embodiment. In addition, the following embodiments may be appropriately combined as long as there is no contradiction.

### Example 1

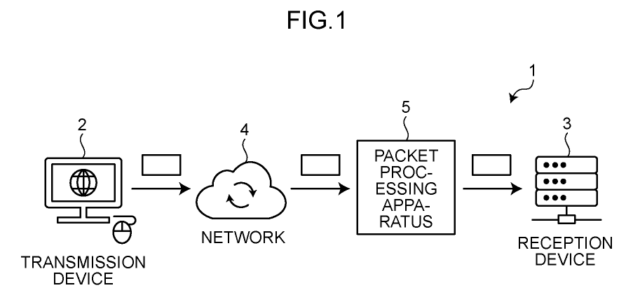

FIG. 1 is an explanatory diagram illustrating an example of a packet communication system 1 according to Example 1. The packet communication system 1 illustrated in FIG. 1 includes a transmission device 2, a reception device 3, a network 4, and a packet processing apparatus 5. The transmission device 2 is, for example, a communication device such as a personal computer that transmits a packet. The reception device 3 is, for example, a communication device such as a server that receives a packet. The network 4 is a communication network that transmits packets between the transmission device 2 and the reception device 3. The packet processing apparatus 5 is a processing apparatus that executes packet processing on the packet from the transmission device 2 and transmits the packet after execution of the packet processing to the reception device 3.

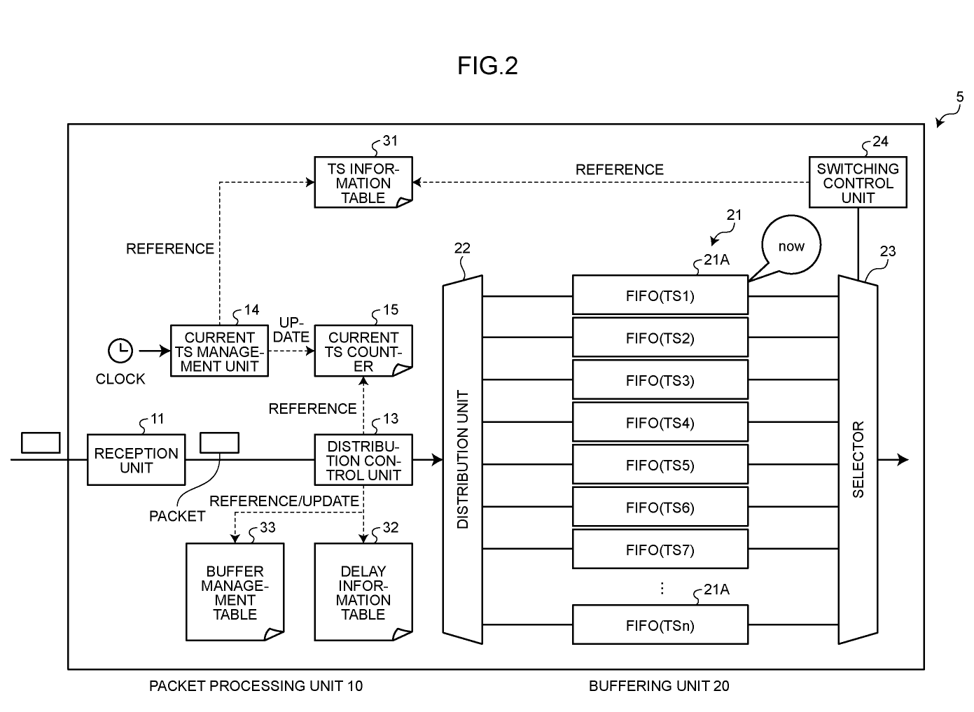

FIG. 2 is an explanatory diagram illustrating an example of the packet processing apparatus 5. The packet processing apparatus 5 illustrated in FIG. 2 includes a packet processing unit 10 and a buffering unit 20. The packet processing unit 10 is a packet processing circuit that processes a packet received from the transmission device 2 and is attachable to and detachable from the packet processing apparatus 5. The buffering unit 20 is a buffering circuit that is attachable to and detachable from the packet processing apparatus 5, which performs storage processing of the received packet and reads and outputs the stored packet.

The buffering unit 20 includes a FIFO (Fast In Fast Out) group 21, a distribution unit 22, a selector 23, and a switching control unit 24. The FIFO group 21 includes a plurality of FIFOs 21A provided for each time slot (TS) number. The TS is a packet read timing. The FIFO group 21 is not provided for each flow to which a packet belongs, but is a buffer group shared among all the flows. Each FIFO 21A is a buffer that stores the received packet and reads and outputs the stored packet according to the TS. In the FIFO group 21, a TS number is assigned to each FIFO 21A. The TS number is a number for identifying the TS. The TS number is information related to time corresponding to timing. For example, in a case of 1024 TS numbers TS1 to TS1024, the FIFO group 21 includes 1024 FIFOs 21A. The FIFO group 21 includes 1024 FIFOs 21A such as a FIFO 21A with a TS number "1", a FIFO 21A with a TS number "2", and a FIFO 21A with a TS number "1024".

The distribution unit 22 is arranged in a preceding stage of the FIFO group 21, and distributes packets to be stored in the FIFO group 21 to the FIFO 21A as a distribution destination. The selector 23 is arranged at a subsequent stage of the FIFO group 21 and selects any one of the FIFOs 21A in the FIFO group 21. During the selection period, the packet accumulated in the FIFO 21A is output. The selector 23 selects the FIFO 21A from which the packet is output.

The switching control unit 24 controls the selector 23 to sequentially switch the FIFO 21A to be read in order of TS numbers in units of TS. The switching control unit 24 sequentially switches the FIFO 21A by controlling the selector 23 at a constant cycle. For example, in a case where 1 TS is 0.1 msec, the switching control unit 24 controls the selector 23 so as to sequentially switch the FIFO 21A to be read in order of the TS number every 0.1 msec. That is, the selector 23 sequentially switches the FIFO 21A in order of TS numbers such as "TS1" → "TS2" → "TS3" →... → "TS1024" → "TS1"→ "TS2" →.... Although the TS number is 1 to 1024 for convenience of description, the TS number is not limited to this, and can be changed as appropriate. The FIFO number for identifying the FIFO 21A is the same as the TS number.

The packet processing unit 10 includes a reception unit 11, a distribution control unit 13, a current TS management unit 14, a current TS counter 15, a TS information table 31, a delay information table 32, and a buffer management table 33. The reception unit 11 is connected to the network 4 and receives a packet from the transmission device 2. The reception unit 11 acquires the flow ID from the received packet. Note that the flow ID is an ID for identifying a flow to which a packet belongs.

The distribution control unit 13 determines the distribution destination FIFO 21A to which the received packet is distributed based on the insertion delay which is the insertion delay amount for each flow ID in the delay information table 32. The distribution control unit 13 determines the distribution destination FIFO 21A based on a constant cycle of the selector 23. That is, the distribution control unit 13 calculates the TS number of the distribution destination corresponding to the read timing according to the insertion delay which is the insertion delay amount for each flow to which the packet belongs, and determines the FIFO 21A of the calculated TS number (FIFO number) of the distribution destination as the distribution destination FIFO 21A. The distribution control unit 13 controls the distribution unit 22 to distribute the reception packet to the determined distribution destination FIFO 21A. Then, the distribution control unit 13 adjusts the delay between the packets by distributing the packets of the corresponding flow to the distribution destination FIFO 21A. That is, in a case where the current TS number is "TS1", the distribution control unit 13 distributes the reception packet to, for example, the FIFO 21A of "TS6", thereby enabling a delay of about 5 msec.

For example, in a case where the distribution destination FIFO 21A to which the reception packet is to be distributed competes with other reception packets, the distribution control unit 13 distributes the reception packets to an empty FIFO 21A having a FIFO number nearest from the distribution destination FIFO 21A. For example, it is assumed that the distribution destination FIFO 21A of "TS6" to which the reception packet is to be distributed competes with other reception packets. In this case, among the FIFOs 21A nearest to the FIFO 21A of "TS6", the empty FIFO 21A is searched as the distribution destination FIFO 21A in the order of the FIFO 21A of "TS7" → the FIFO 21A of "TS8" → the FIFO 21A of "TS9" →.... Note that, since the input rate is basically equal to the output rate, it is a rare case that different reception packets compete with one FIFO 21A. Even in this case, only a few FIFOs 21A are shifted, and the influence on the entire packet communication system 1 is minor.

The current TS management unit 14 manages the current TS counter 15 with reference to the TS information table 31. The current TS counter 15 counts the TS number in units of TS by using its own clock source, and counts the current TS number.

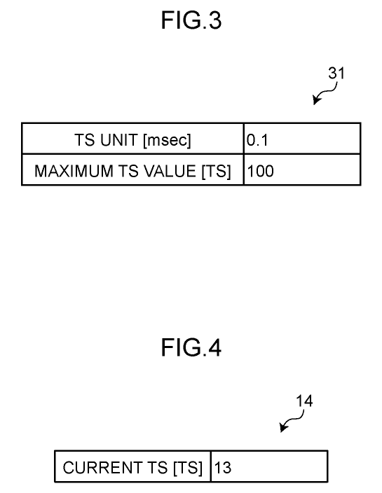

FIG. 3 is an explanatory diagram illustrating an example of a table configuration of the TS information table 31. The TS information table 31 illustrated in FIG. 3 manages a TS unit and a maximum TS number. The TS unit is a time corresponding to 1 TS, for example, 1 msec. The maximum TS number is a TS number of the maximum TS. For example, for 1024 TS, the minimum TS number is "TS1" and the maximum TS number is "TS1024". The current TS counter 15 counts the current TS number with reference to the TS information table 31.

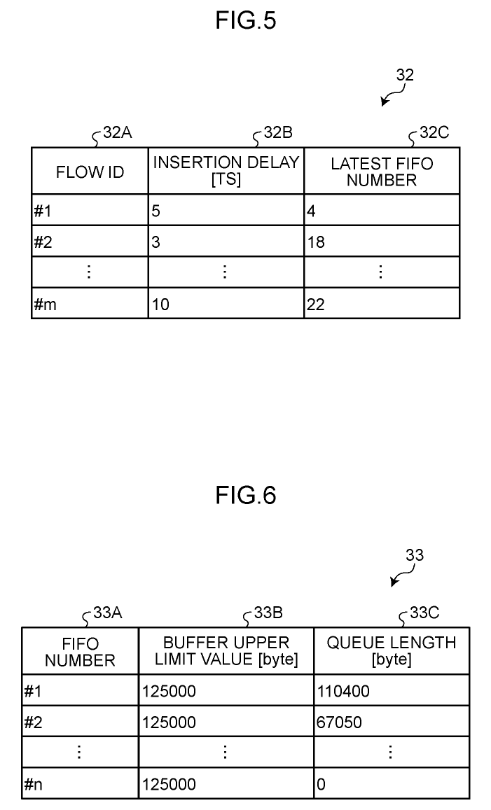

FIG. 4 is an explanatory diagram illustrating an example of a table configuration of the current TS management unit 14. The current TS management unit 14 illustrated in FIG. 4 manages the TS number of the current TS while counting the TS number of the current TS with the current TS counter 15.

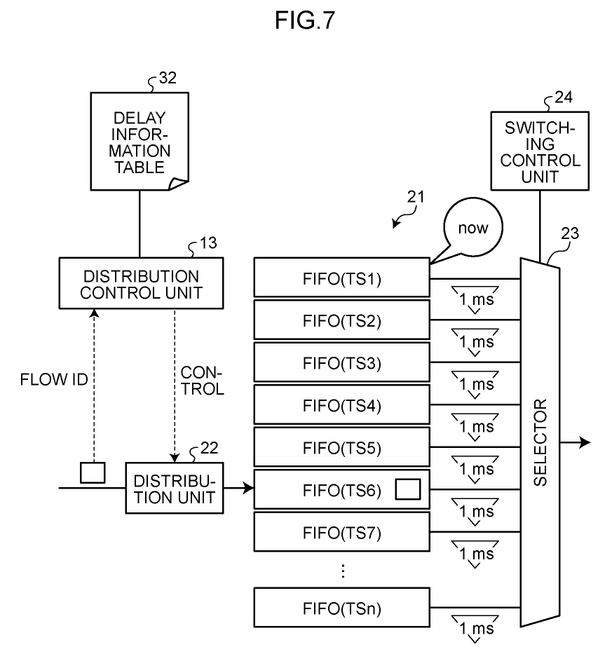

FIG. 5 is an explanatory diagram illustrating an example of a table configuration of the delay information table 32. The delay information table 32 illustrated in FIG. 5 manages the insertion delay 32B and the latest FIFO number 32C for each flow ID 32A. The flow ID 32A is an ID of a VLAN for identifying a flow. The insertion delay 32B is an insertion delay amount imposed on each packet of the flow. The latest FIFO number 32C is a FIFO number for identifying the FIFO 21A to which the latest reception packet of the flow is distributed and stored. The distribution control unit 13 refers to the delay information table 32, and can recognize, for example, that the insertion delay is 5 TS and the latest FIFO number is "TS4" in the case of the flow ID of #1, and that the insertion delay is 3 TS and the latest FIFO number is "TS18" in the case of the flow ID of #2.

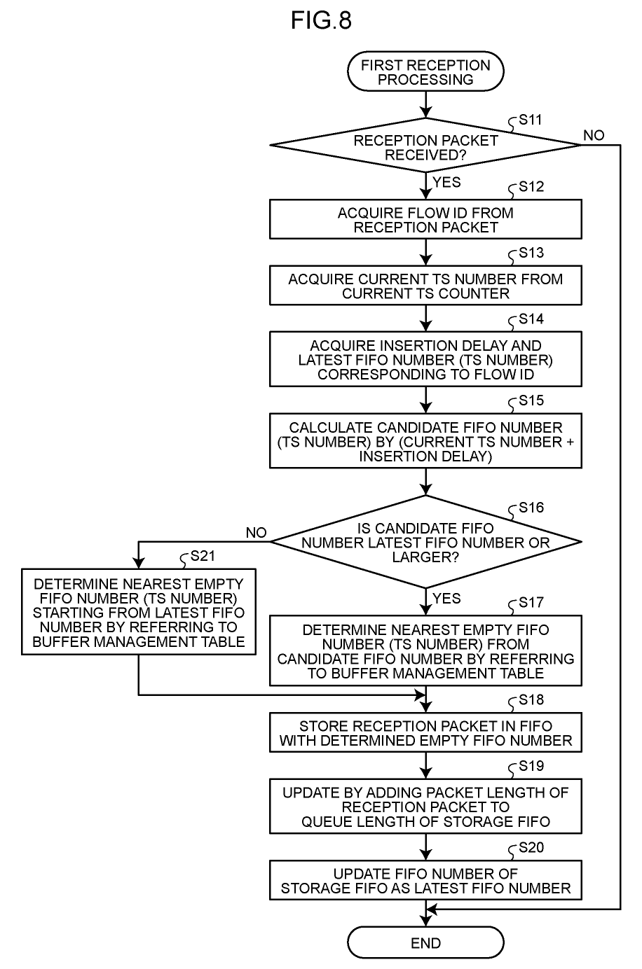

FIG. 6 is an explanatory diagram illustrating an example of a table configuration of the buffer management table 33. The buffer management table 33 illustrated in FIG. 6 manages a buffer upper limit value 33B and a queue length 33C for each FIFO number 33A. The FIFO number 33A is a number for identifying the FIFO 21A. The buffer upper limit value 33B is an upper limit value of the buffering amount of the FIFO 21A. The queue length 33C is a packet length of a packet stored in the FIFO 21A. The distribution control unit 13 refers to the buffer management table 33, and can recognize, for example, that the buffer upper limit value 33B of the FIFO 21A of the FIFO number of #1 is 125000 bytes and the queue length 33C is 110400 bytes. Note that the FIFO number of #1 is "TS1" of the TS number, and the FIFO number of #2 is "TS2" of the TS number. Further, the distribution control unit 13 refers to the queue length 33C in the buffer management table 33 and can recognize an empty FIFO 21A from the FIFO group 21.

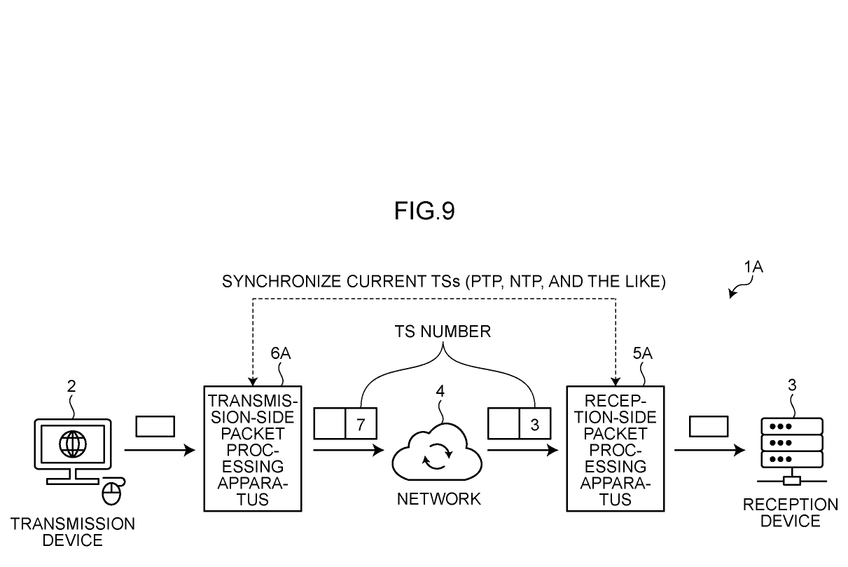

FIG. 7 is an explanatory diagram illustrating an example of a buffering operation of the packet processing apparatus 5. When receiving a packet from the transmission device 2, the reception unit 11 in the packet processing apparatus 5 acquires a flow ID in the packet. The distribution control unit 13 in the packet processing apparatus 5 acquires the insertion delay (5 TS) corresponding to the acquired flow ID from the delay information table 32.

The distribution control unit 13 calculates "TS6" by adding the insertion delay "5 TS" to the current TS number "TS1" currently counted by the current TS counter 15. Then, the distribution control unit 13 determines the FIFO 21A of "TS6" as the distribution destination FIFO 21A, and stores the reception packet in the FIFO 21A of "TS6".

Then, the switching control unit 24 controls the selector 23 to sequentially switch and output the output of the FIFO 21A in order of TS number every 1 msec. Then, the selector 23 reads and outputs the packet of the FIFO 21A of "TS6" at the timing of "TS6".

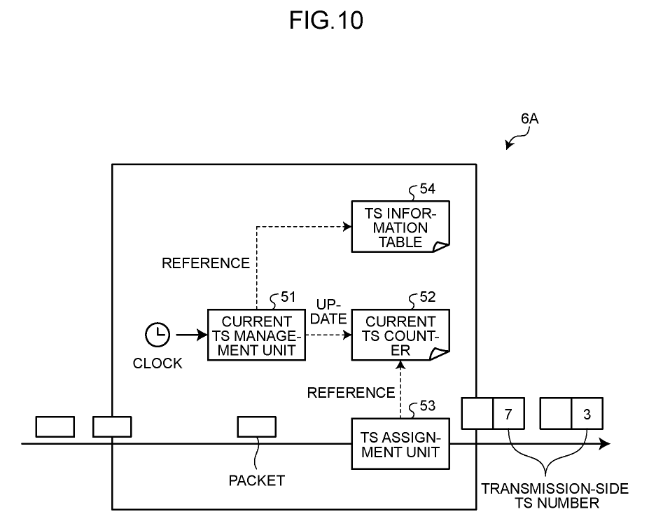

FIG. 8 is a flowchart illustrating an example of a processing operation of the packet processing apparatus 5 related to first reception processing. In FIG. 8, the reception unit 11 in the packet processing apparatus 5 determines whether a reception packet from the transmission device 2 has been received (step S11). When the reception packet has been received (step S11: Yes), the reception unit 11 acquires the flow ID from the reception packet (step S12).

Further, the distribution control unit 13 acquires the current TS from the current TS counter 15 (step S13). The distribution control unit 13 refers to the delay information table 32 and acquires the insertion delay 32B and the latest FIFO number 32C corresponding to the flow ID 32A (step S14). The distribution control unit 13 calculates a FIFO number corresponding to a TS number corresponding to (current TS number + insertion delay) (step S15). Note that the current TS number is acquired from the current TS counter 15.

The distribution control unit 13 uses the calculated FIFO number as a candidate FIFO number to determine whether the candidate FIFO number is equal to or larger than the latest FIFO number (step S16). In a case where the candidate FIFO number is equal to or larger than the latest FIFO number (step S16: Yes), the distribution control unit 13 refers to the buffer management table 33 to determine the FIFO number of the nearest empty FIFO 21A after the FIFO number corresponding to the TS number corresponding to (current TS number + insertion delay) (step S17).

The distribution control unit 13 stores the reception packet in the empty FIFO 21A corresponding to the determined FIFO number (step S18). Further, the distribution control unit 13 adds the packet length of the reception packet to the queue length 33C of the FIFO 21A storing the reception packet and updates the content of the buffer management table 33 (step S19). Further, the distribution control unit 13 updates the content of the delay information table 32 with the FIFO number of the FIFO 21A storing the reception packet as the latest FIFO number 32C (step S20), and ends the processing operation illustrated in FIG. 8.

In a case where the candidate FIFO number is not equal to or larger than the latest FIFO number (step S16: No), the distribution control unit 13 refers to the buffer management table 33 and determines the FIFO number of the nearest empty FIFO 21A after the latest FIFO number (step S21). The distribution control unit 13 proceeds to the processing of step S18 to store the reception packet in the empty FIFO 21A of the determined FIFO number.

In a case where the reception packet has not been received (step S11: No), the distribution control unit 13 ends the processing operation illustrated in FIG. 8.

The distribution control unit 13 acquires the insertion delay and the latest FIFO number corresponding to the flow ID of the reception packet. The distribution control unit 13 calculates the candidate FIFO number by (current TS number + insertion delay). In a case where the calculated candidate FIFO is equal to or larger than the latest FIFO number, the distribution control unit 13 determines the nearest FIFO number from the candidate FIFO numbers. As a result, the FIFO 21A as the reception packet distribution destination can be determined.

In a case where the calculated candidate FIFO is not equal to or larger than the latest FIFO number, the distribution control unit 13 determines the nearest FIFO number starting from the latest FIFO number. As a result, the FIFO 21A as the reception packet distribution destination can be determined.

The packet processing apparatus 5 according to Example 1 includes a FIFO group 21 including a plurality of FIFOs 21A provided for each TS number that store packets that can be read for each TS. When receiving a packet from the transmission device 2, the distribution control unit 13 in the packet processing apparatus 5 calculates a TS number (FIFO number) of a distribution destination according to a TS-converted insertion delay which is a delay amount for each flow to which the packet belongs. Further, the distribution control unit 13 determines the FIFO 21A of the calculated FIFO number of the distribution destination as the distribution destination FIFO from the FIFO group 21. The distribution unit 22 distributes the received packet to the determined distribution destination FIFO 21A. As a result, delay and jitter can be adjusted.

The switching control unit 24 in the packet processing apparatus 5 controls the selector 23 so as to switch, from the FIFO group 21, the output of one FIFO 21A in which the read output is performed in order of the TS number for each TS. As a result, the packets stored in the FIFO group 21 can be sequentially output in order of the TS number.

The distribution control unit 13 calculates the TS number (FIFO number) of the distribution destination according to the TS-converted insertion delay and the current TS number, and the distribution control unit 13 determines the distribution destination FIFO 21A of the calculated FIFO number of the distribution destination. As a result, the current TS number of the current TS counter 15 can be used to determine the distribution destination FIFO 21A of the reception packet.

Note that the packet processing apparatus 5 according to Example 1 has been described with an example in which the current TS is counted from the current TS counter 15, and the FIFO number of the FIFO 21A of the distribution destination is acquired using the current TS number and the insertion delay. However, the current TS number may be synchronized between a transmission-side packet processing apparatus 6A and a reception-side packet processing apparatus 5A, and an embodiment thereof will be described below as Example 2. Note that the same components as those of the packet communication system 1 of Example 1 are denoted by the same reference numerals, and the description of the overlapping components and operations will be omitted.

### Example 2

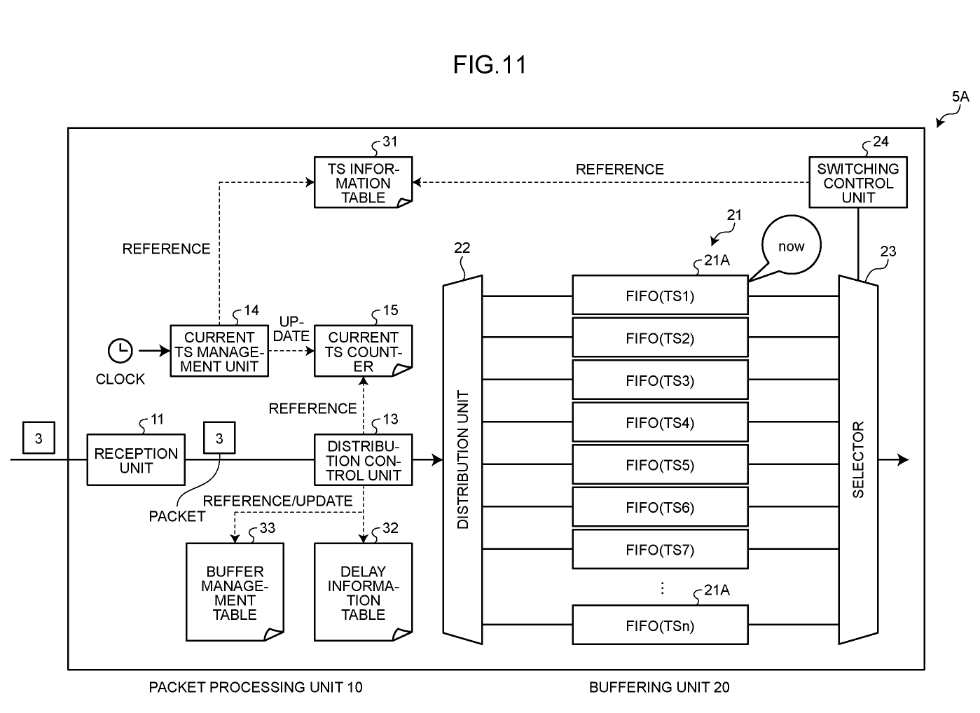

FIG. 9 is an explanatory diagram illustrating an example of a packet communication system 1A according to Example 2. The packet communication system 1A illustrated in FIG. 9 includes a transmission device 2, a reception device 3, a network 4, a transmission-side packet processing apparatus 6A, and a reception-side packet processing apparatus 5A.

The transmission-side packet processing apparatus 6A is a packet processing apparatus that connects the transmission device 2 and the network 4 and processes a transmission packet. The reception-side packet processing apparatus 5A is a packet processing apparatus that connects the reception device 3 and the network 4 and processes a reception packet.

The transmission-side packet processing apparatus 6A and the reception-side packet processing apparatus 5A synchronize the current TSs in advance using an external synchronization unit such as PTP (Precision Time Protocol) or NTP (Network Time Protocol).

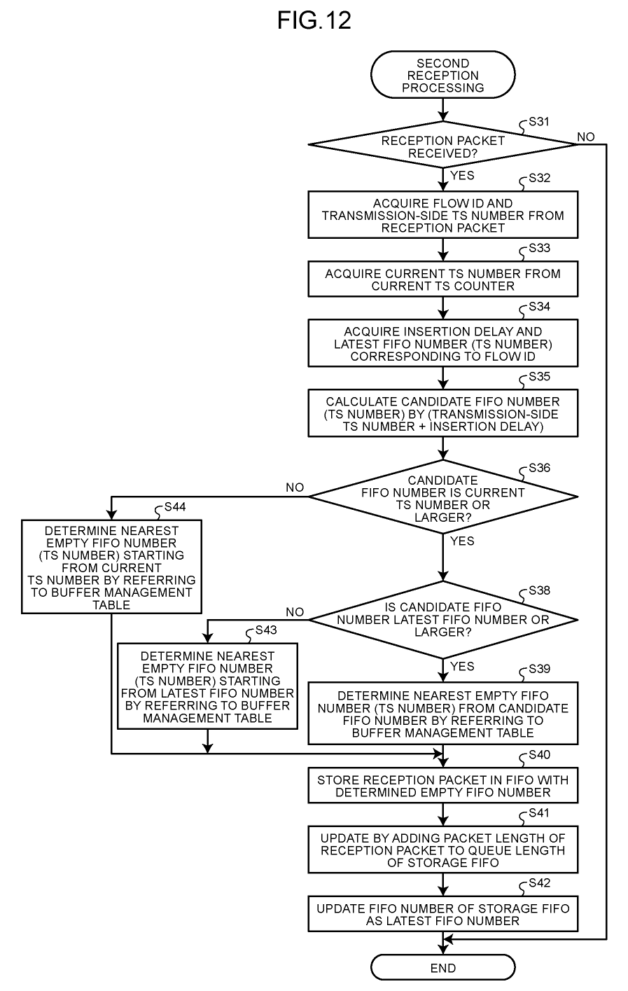

FIG. 10 is an explanatory diagram illustrating an example of the transmission-side packet processing apparatus 6A. The transmission-side packet processing apparatus 6A illustrated in FIG. 10 includes a current TS management unit 51, a current TS counter 52, a TS assignment unit 53, and a TS information table 54.

The current TS management unit 51 manages the current TS number counted by the current TS counter 52 with reference to the TS information table 54. The current TS counter 52 counts the TS number in units of TS by using its own clock source, and counts the current TS number. The TS information table 54 manages a TS unit and a maximum TS number. Note that the content of the TS information table 54 is the same as the content of the TS information table 31.

When transmitting the transmission packet to the reception device 3, the TS assignment unit 53 assigns a flow ID and a transmission-side TS number, which is a current TS number, to the transmission packet using, for example, a VLAN tag. The transmission-side TS number is a first read number. Then, the TS assignment unit 53 transmits the transmission packet to the network 4. When transmitting a packet to the reception-side packet processing apparatus 5A, the transmission-side packet processing apparatus 6A transmits a packet including a transmission-side TS number which is a current first TS number.

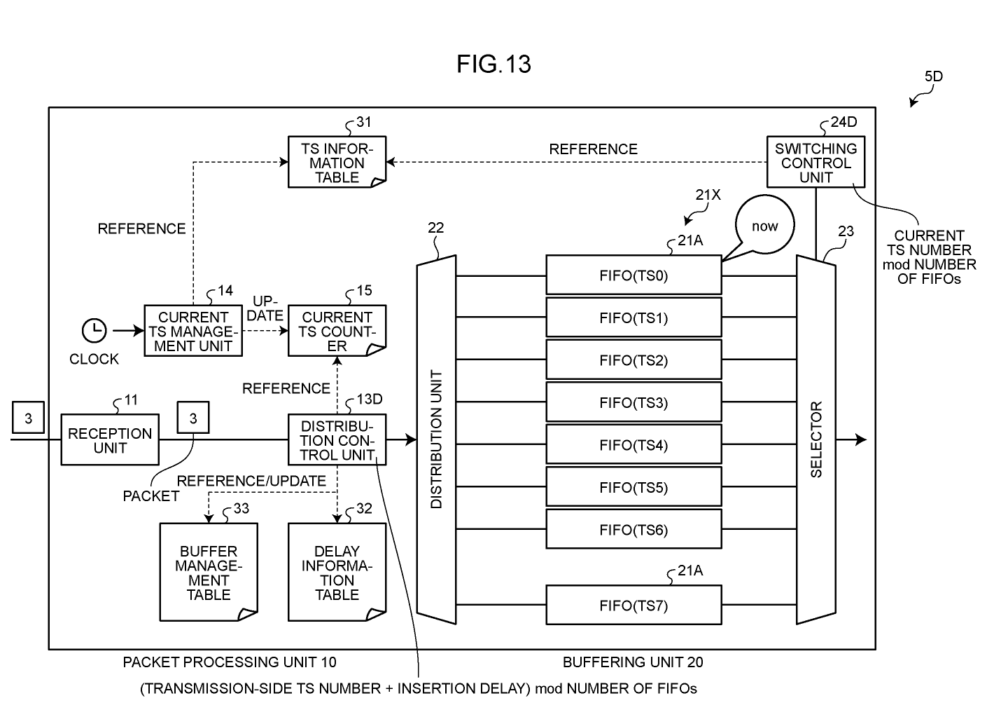

FIG. 11 is an explanatory diagram illustrating and example of the reception-side packet processing apparatus 5A. The packet processing unit 10 in the reception-side packet processing apparatus 5A illustrated in FIG. 11 includes a reception unit 11, a distribution control unit 13, a current TS management unit 14, and a current TS counter 15. The packet processing unit 10 includes a TS information table 31, a delay information table 32, and a buffer management table 33. The buffering unit 20 in the reception-side packet processing apparatus 5A includes a FIFO group 21, a selector 23, and a switching control unit 24. When the reception packet has been received, the reception unit 11 refers to the flow ID and the current TS number (transmission-side TS number) in the reception packet.

When receiving the packet from the transmission-side packet processing apparatus 6A, the reception-side packet processing apparatus 5A corrects a second TS number, which is the current TS number, based on the transmission-side TS number in the packet. As a result, TS synchronization between the transmission-side packet processing apparatus 6A and the reception-side packet processing apparatus 5A can be secured.

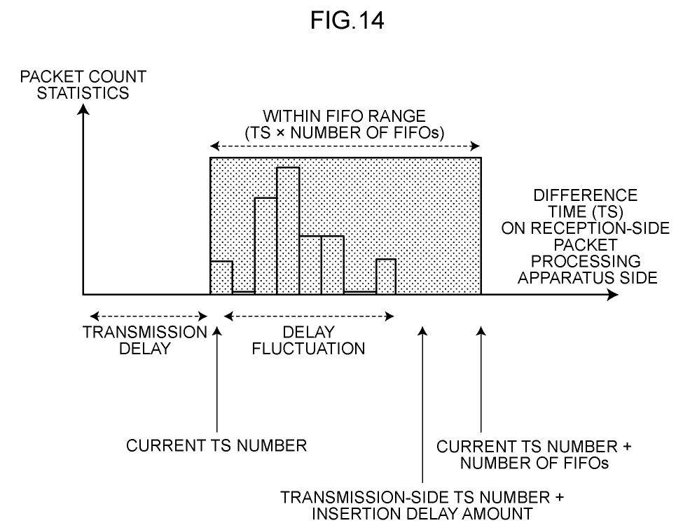

FIG. 12 is a flowchart illustrating an example of a processing operation of the reception-side packet processing apparatus 5A related to second reception processing. Note that the reception-side packet processing apparatus 5A synchronizes the current TSs in advance with the transmission-side packet processing apparatus 6A using an external synchronization unit. In FIG. 12, the reception unit 11 in the reception-side packet processing apparatus 5A determines whether a reception packet has been received (step S31). When the reception packet has been received (step S31: Yes), the reception unit 11 acquires the flow ID and the transmission-side TS number from the reception packet (step S32).

Further, the distribution control unit 13 acquires the current TS number from the current TS counter 15 (step S33). The distribution control unit 13 refers to the delay information table 32 and acquires the insertion delay 32B and the latest FIFO number 32C corresponding to the flow ID 32A (step S34). The distribution control unit 13 calculates a FIFO number corresponding to a TS number corresponding to (transmission-side TS number + insertion delay) as a candidate FIFO number (step S35).

The distribution control unit 13 determines whether the calculated candidate FIFO number is equal to or larger than the current TS number (step S36). In a case where the candidate FIFO number is equal to or larger than the current TS number (step S36: Yes), the distribution control unit 13 determines whether the calculated candidate FIFO number is equal to or larger than the latest FIFO number (step S38). In a case where the candidate FIFO number is equal to or larger than the latest FIFO number (step S38: Yes), the distribution control unit 13 refers to the buffer management table 33 and determines the FIFO number of the nearest empty FIFO 21A from the candidate FIFO number (step S39).

The distribution control unit 13 stores the reception packet in the empty FIFO 21A corresponding to the determined FIFO number (step S40). Further, the distribution control unit 13 adds the packet length of the reception packet to the queue length 33C of the FIFO 21A storing the reception packet and updates the content of the buffer management table 33 (step S41). Further, the distribution control unit 13 updates the content of the delay information table 32 with the FIFO number of the FIFO 21A storing the reception packet as the latest FIFO number (step S42), and ends the processing operation illustrated in FIG. 12.

In a case where the candidate FIFO number is not equal to or larger than the latest FIFO number (step S38: No), the distribution control unit 13 refers to the buffer management table 33 and determines the FIFO number of the nearest empty FIFO 21A starting from the latest FIFO number (step S43). Then, the distribution control unit 13 proceeds to the processing of step S40.

In a case where the candidate FIFO number is not equal to or larger than the current TS number (step S36: No), the distribution control unit 13 refers to the buffer management table 33 and determines the FIFO number of the nearest empty FIFO 21A starting from the current TS number (step S44). Then, the distribution control unit 13 proceeds to the processing of step S40.

In a case where the reception packet has not been received (step S31: No), the distribution control unit 13 ends the processing operation illustrated in FIG. 12.

The distribution control unit 13 calculates the candidate FIFO number by (transmission-side TS number of the reception packet + insertion delay). The distribution control unit 13 determines whether the candidate FIFO number is equal to or larger than the current TS number. In a case where the candidate FIFO number is equal to or larger than the current TS number, the distribution control unit 13 determines whether the candidate FIFO number is equal to or larger than the latest FIFO number. In a case where the candidate FIFO number is equal to or larger than the latest FIFO number, the distribution control unit 13 determines the nearest empty FIFO number from the candidate FIFO numbers. As a result, the FIFO 21A as the reception packet distribution destination can be determined.

In a case where the candidate FIFO number is not equal to or larger than the current TS number, the distribution control unit 13 determines the nearest empty FIFO number starting from the current TS number. As a result, the FIFO 21A as the reception packet distribution destination can be determined.

In a case where the candidate FIFO number is not equal to or larger than the latest FIFO number, the distribution control unit 13 determines the nearest empty FIFO number starting from the latest FIFO number. As a result, the FIFO 21A as the reception packet distribution destination can be determined.

The distribution control unit 13 in the reception-side packet processing apparatus 5A of Example 2 calculates the FIFO number of the distribution destination according to the TS-converted insertion delay and the transmission-side TS number of the received packet, and determines the distribution destination FIFO 21A of the calculated FIFO number of the distribution destination. As a result, as a matter of course, the delay and the jitter can be adjusted, and the distribution destination FIFO 21A of the reception packet can be determined using the TS number in the received packet.

When transmitting a packet to the reception-side packet processing apparatus 5A, the transmission-side packet processing apparatus 6A transmits a packet including a transmission-side TS number which is a current first TS number. When receiving the packet from the transmission-side packet processing apparatus 6A, the reception-side packet processing apparatus 5A corrects the second TS number, which is the current TS number, based on the first TS number in the packet. As a result, TS synchronization between the transmission-side packet processing apparatus 6A and the reception-side packet processing apparatus 5A can be secured.

Note that, in the reception-side packet processing apparatus 5A of Example 2, in a case where the delay amount of the transmission path between the reception-side packet processing apparatus 5A and the transmission-side packet processing apparatus 6A is large, the FIFO group 21 needs the FIFO 21A of the FIFO amount capable of absorbing the delay amount. For example, in a case where the delay amount between Japan and the United States is 100 msec and the delay fluctuation width on the transmission path is 10 msec, the FIFO 21A of the FIFO amount of 110 msec is needed. That is, in the reception-side packet processing apparatus 5A, it is needed to increase the FIFO 21A according to the insertion delay in order to satisfy the relationship of insertion delay < FIFO amount. Therefore, in order to cope with such a situation, an embodiment in which delay control can be achieved while reducing the FIFO amount will be described below as Example 3. Note that the same components as those of the packet communication system 1A of Example 2 are denoted by the same reference numerals, and the description of the overlapping components and operations will be omitted.

### Example 3

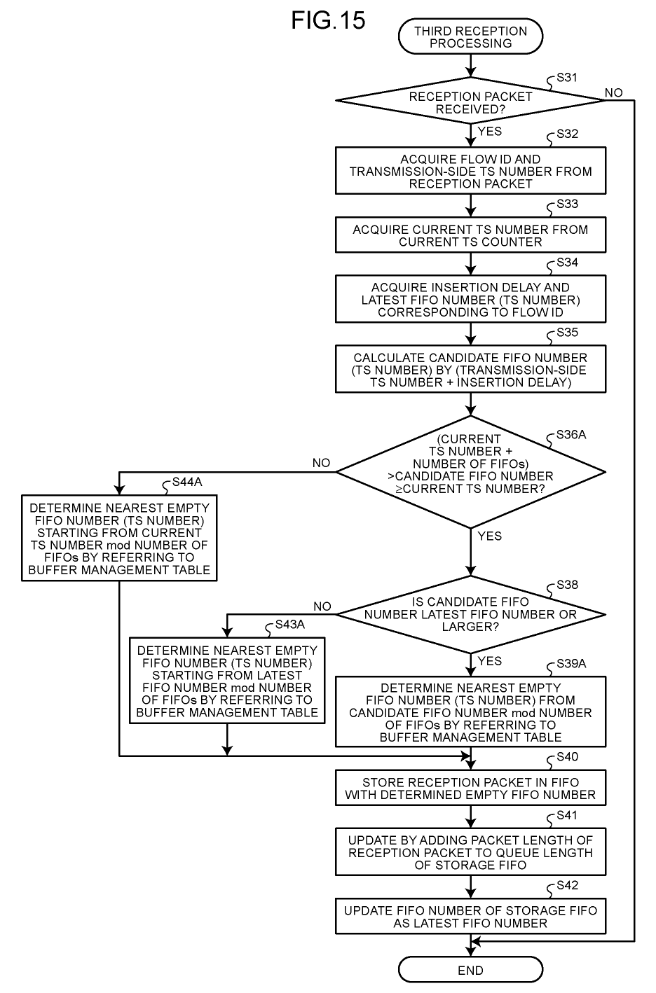

FIG. 13 is an explanatory diagram illustrating an example of a reception-side packet processing apparatus 5D according to Example 3. The reception-side packet processing apparatus 5D illustrated in FIG. 13 includes a packet processing unit 10 and a buffering unit 20. The packet processing unit 10 includes a reception unit 11, a distribution control unit 13D, a current TS management unit 14, a current TS counter 15, a TS information table 31, a delay information table 32, and a buffer management table 33. The buffering unit 20 includes a FIFO group 21X, a distribution unit 22, a selector 23, and a switching control unit 24D.

The FIFO group 21X includes FIFOs 21A corresponding to the FIFO amount capable of absorbing the delay amount corresponding to the delay fluctuation width. Note that it is assumed that the reception-side packet processing apparatus 5D observes and grasps the delay fluctuation width on the transmission path in advance. The FIFO group 21 of Example 2 requires the FIFO 21A corresponding to the FIFO amount corresponding to (delay amount + delay fluctuation width), whereas the FIFO group 21X of Example 3 requires the FIFO 21A corresponding to the FIFO amount corresponding to the delay fluctuation width, and thus, the number of FIFOs m needed for delay control can be greatly reduced.

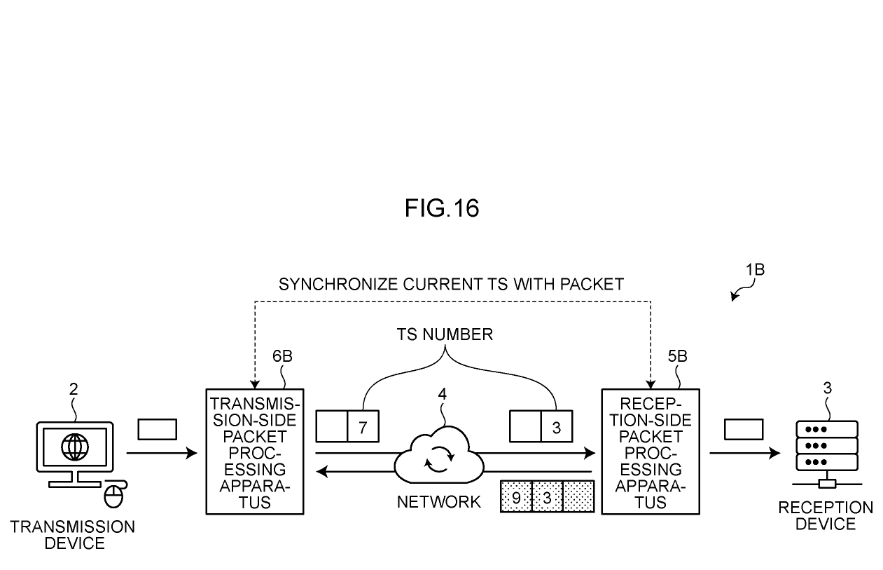

FIG. 14 is an explanatory diagram illustrating an example of a FIFO range. In FIG. 14, the difference time (TS) of the reception-side packet processing apparatus 5D is plotted on the horizontal axis, and the number of packets is plotted on the vertical axis. The reception-side packet processing apparatus 5D prepares the FIFOs 21A of the number of FIFOs m in the FIFO group 21X to the extent that the FIFO range in which the reception packet can be output at the timing of (transmission-side TS number + insertion delay amount) through delay fluctuation can be covered from the current TS number of the reception packet that arrives after the transmission delay of the transmission path. The FIFO range is within a range from the current TS number to (current TS number + number of FIFOs m).

That is, the FIFO group 21X only needs to be the number of FIFOs m of the FIFO 21A with the delay fluctuation width < the FIFO amount, and even in the case of the insertion delay ≥ the FIFO amount, the reception-side packet processing apparatus 5D can determine the distribution destination FIFO 21A of the reception packet using the TS number in the received packet as a matter of course of adjusting the delay and the jitter.

When the reception packet has been received, the distribution control unit 13D acquires the transmission- side TS number in the reception packet and acquires the insertion delay corresponding to the flow ID in the reception packet from the delay information table 32. The distribution control unit 13D determines, as the distribution destination FIFO 21A, the FIFO number of the TS number corresponding to (transmission-side TS number + insertion delay) mod number of FIFOs (m), that is, the remainder obtained by dividing (transmission-side TS number + insertion delay) by the number of FIFOs (m).

The switching control unit 24D controls the selector 23 to switch, as the FIFO 21A to be read, the FIFO number of the TS number corresponding to the current TS number mod number of FIFOs (m), that is, the remainder obtained by dividing the current TS number by the number of FIFOs (m).

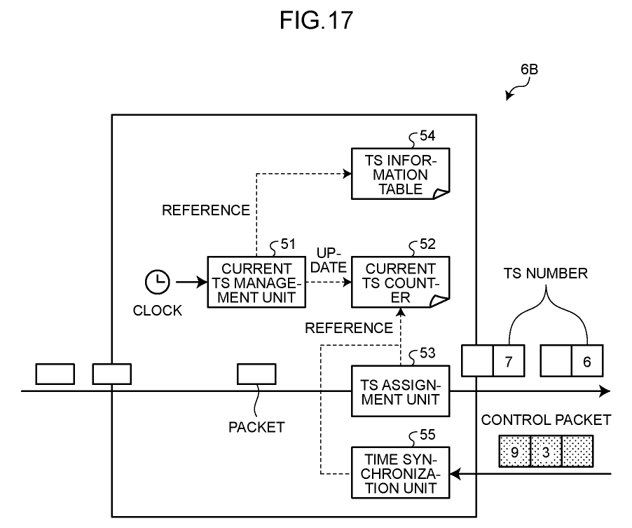

FIG. 15 is a flowchart illustrating an example of a processing operation of the reception-side packet processing apparatus 5D related to third reception processing. Note that the reception-side packet processing apparatus 5D synchronizes the current TSs in advance with the transmission-side packet processing apparatus 6 using an external synchronization unit. In FIG. 15, the reception unit 11 in the reception-side packet processing apparatus 5D determines whether a reception packet has been received in step S31. When the reception packet has been received, the reception unit 11 executes the processing of step S32 to acquire the flow ID and the transmission-side TS number from the reception packet.

Further, the distribution control unit 13D acquires the current TS number from the current TS counter 15 in step S33. The distribution control unit 13D refers to the delay information table 32 and acquires the insertion delay 32B and the latest FIFO number 32C corresponding to the flow ID 32A in step S34. The distribution control unit 13D executes the processing of step S35 to calculate a FIFO number corresponding to a TS number corresponding to (transmission-side TS number + insertion delay) as a candidate FIFO number.

The distribution control unit 13D determines whether the candidate FIFO number is (current TS number + number of FIFOs) > candidate FIFO number ≥ current TS number (step S36A). In a case where the candidate FIFO number is (current TS number + number of FIFOs) > candidate FIFO number ≥ current TS number (step S36A: Yes), the distribution control unit 13D executes the processing of step S38 to determine whether the calculated candidate FIFO number is equal to or larger than the latest FIFO number.

In a case where the candidate FIFO number is equal to or larger than the latest FIFO number, the distribution control unit 13D calculates candidate FIFO number mod number of FIFOs. The distribution control unit 13D refers to the buffer management table 33 and determines the FIFO number of the nearest empty FIFO 21A from the calculated (candidate FIFO number mod number of FIFOs) (step S39A).

The distribution control unit 13D executes the processing of step S40 to store the reception packet in the empty FIFO 21A corresponding to the determined FIFO number.

In a case where the candidate FIFO number is not equal to or larger than the latest FIFO number in step S38, the distribution control unit 13D calculates (latest FIFO number mod number of FIFOs). The distribution control unit 13D refers to the buffer management table 33 and determines the FIFO number of the nearest empty FIFO 21A starting from the calculated (latest FIFO number mod number of FIFOs) (step S43A). Then, the distribution control unit 13D proceeds to the processing of step S40.

In a case where the candidate FIFO number is not (current TS number + number of FIFOs) > candidate FIFO number ≥ current TS number (step S36A: No), the distribution control unit 13D calculates (current TS number mod number of FIFOs). Then, the distribution control unit 13D refers to the buffer management table 33 and determines the FIFO number of the nearest empty FIFO 21A starting from the calculated (current TS number mod number of FIFOs) (step S44A). Then, the distribution control unit 13D proceeds to the processing of step S40.

In the next third reception processing, there are processes of step S39A, step S43A, and step S44A in determining the FIFO number of the empty FIFO 21A in which the reception packet is stored. Therefore, a case where each processing is executed will be described.

First, a processing case of step S39A of determining the FIFO number of the nearest empty FIFO 21A from the calculated (candidate FIFO number mod number of FIFOs) will be described. As a premise, it is assumed that a transmission-side TS number of a reception packet is "1", an insertion delay is "108", a current TS number is "104", a latest FIFO position is "107", the number of FIFOs is "8", and an assumed delay is "103" to "106".

The distribution control unit 13D calculates a candidate FIFO number corresponding to the TS number "109" corresponding to (transmission-side TS number "1" + insertion delay "108"). Further, the distribution control unit 13D determines whether the calculated candidate FIFO number "109" is (current TS number "104" + number of FIFOs "8") > candidate FIFO number "109" ≥ current TS number "104". Since the calculated candidate FIFO number "109" is (current TS number + number of FIFOs) > candidate FIFO number ≥ current TS number, the distribution control unit 13D determines whether the candidate FIFO number "109" is equal to or larger than the latest FIFO number "107".

Since the candidate FIFO number "109" is equal to or larger than the latest FIFO number "107", the distribution control unit 13D calculates "5" using the candidate FIFO number "109" mod the number of FIFOs "8". The distribution control unit 13D refers to the buffer management table 33 and determines the FIFO number of the nearest empty FIFO 21A from the calculated "5". The distribution control unit 13D stores the reception packet in the empty FIFO 21A corresponding to the determined FIFO number.

Then, the switching control unit 24D outputs the packet in the FIFO 21A with the FIFO number of "0" obtained by calculating the current TS number "104" mod the number of FIFOs "8".

Next, a processing case of step S44A of determining the FIFO number of the nearest empty FIFO 21A starting from the calculated current TS number mod number of FIFOs will be described. As a premise, it is assumed that a transmission-side TS number of a reception packet is "1", an insertion delay is "108", a current TS number is "112", a latest FIFO position is "107", the number of FIFOs is "8", and an assumed delay is "103" to "106".

The distribution control unit 13D calculates a candidate FIFO number corresponding to the TS number "109" corresponding to (transmission-side TS number "1" + insertion delay "108"). Further, the distribution control unit 13D determines whether the calculated candidate FIFO number "109" is (current TS number "112" + number of FIFOs "8") > candidate FIFO number "109" ≥ current TS number "112". Since the calculated candidate FIFO number "109" is not (current TS number + the number of FIFOs) > candidate FIFO number ≥ current TS number, the distribution control unit 13D calculates "0" using the current TS number "112" mod the number of FIFOs "8". The distribution control unit 13D refers to the buffer management table 33 and determines the FIFO number of the nearest empty FIFO 21A from the calculated "0". The distribution control unit 13D stores the reception packet in the empty FIFO 21A corresponding to the determined FIFO number.

Then, the switching control unit 24D outputs the packet in the FIFO 21A with the FIFO number of "0" obtained by calculating the current TS number "112" mod the number of FIFOs "8". As a result, in a case where the arrival of the reception packet is later than expected or in a case where the arrival of the reception packet is too early, the reception-side packet processing apparatus 5D puts the received packet into the FIFO 21A of the current TS for immediate output.

A processing case of step S43A of determining the FIFO number of the nearest empty FIFO 21A starting from the calculated latest FIFO number mod number of FIFOs will be described. As a premise, it is assumed that a transmission-side TS number of a reception packet is "1", an insertion delay is "108", a current TS number is "104", a latest FIFO position is "110", the number of FIFOs is "8", and an assumed delay is "103" to "106".

The distribution control unit 13D calculates a candidate FIFO number corresponding to the TS number "109" corresponding to (transmission-side TS number "1" + insertion delay "108"). Further, the distribution control unit 13D determines whether the calculated candidate FIFO number "109" is (current TS number "104" + number of FIFOs "8") > candidate FIFO number "109" ≥ current TS number "104" or more. Then, since the calculated candidate FIFO number "109" is (current TS number "104" + number of FIFOs "8") > candidate FIFO number "109" ≥ current TS number "104" or more, the distribution control unit 13D determines whether the candidate FIFO number "109" is equal to or larger than the latest FIFO number "110".

Since the candidate FIFO number "109" is not equal to or larger than the latest FIFO number "110", the distribution control unit 13D causes order reversal. Therefore, the distribution control unit 13D calculates "6" using the latest FIFO number "110" mod the number of FIFOs "8". The distribution control unit 13D refers to the buffer management table 33 and determines the FIFO number "7" of the nearest empty FIFO 21A starting from the calculated "6". The distribution control unit 13D stores the reception packet in the empty FIFO 21A corresponding to the determined FIFO number.

Then, the switching control unit 24D outputs the packet in the FIFO 21A of the FIFO number of "0" obtained by calculating the current TS number "104" mod the number of FIFOs "8". As a result, in a case where the insertion delay is slightly reduced by the setting change (109→108), a situation of order reversal in which the insertion slot is inserted before the latest FIFO position as the calculation result occurs, but in the reception-side packet processing apparatus 5D, the situation of order reversal can be avoided.

The distribution control unit 13D in the reception-side packet processing apparatus 5D of Example 3 includes only the FIFO 21A corresponding to the delay fluctuation of the FIFO group 21X, calculates the FIFO number of the distribution destination according to the TS-converted insertion delay, the transmission-side TS number of the received packet, and the number of FIFOs, and determines the distribution destination FIFO 21A of the calculated FIFO number of the distribution destination. As a result, the reception-side packet processing apparatus 5D can adjust delay and jitter while reducing the number of FIFOs in the FIFO group 21X.

The distribution control unit 13D calculates the candidate FIFO number by (transmission-side TS number of the reception packet + insertion delay). The distribution control unit 13D determines whether the calculated candidate FIFO number is (current TS number + number of FIFOs) > candidate FIFO number ≥ current TS number. In a case where the calculated candidate FIFO number is (current TS number + number of FIFOs) > candidate FIFO number ≥ current TS number, the distribution control unit 13D determines whether the candidate FIFO number is equal to or larger than the latest FIFO number. In a case where the candidate FIFO number is equal to or larger than the latest FIFO number, the distribution control unit 13D determines the nearest empty FIFO number from (the candidate FIFO number mod the number of FIFOs). As a result, the FIFO 21A as the reception packet distribution destination can be determined.

In a case where the calculated candidate FIFO number is not (current TS number + number of FIFOs) > candidate FIFO number ≥ current TS number, the distribution control unit 13D calculates the nearest empty FIFO number starting from (the current TS number mod the number of FIFOs). As a result, even when the arrival of the reception packet is slower or earlier than expected, the FIFO 21A to as the reception packet distribution destination can be determined.

In a case where the candidate FIFO number is not equal to or larger than the latest FIFO number, the distribution control unit 13D determines the nearest empty FIFO number starting from (the latest FIFO number mod the number of FIFOs). As a result, the FIFO 21A as the reception packet distribution destination can be determined while avoiding order reversal.

Note that an example is illustrated in which the current TS is synchronized between the transmission-side packet processing apparatus 6A and the reception-side packet processing apparatus 5A of Example 2 by utilizing an external synchronization unit such as PTP or NTP. However, synchronization may be performed using a TS assigned to a control packet without using an external synchronization unit, and an embodiment thereof will be described below as Example 4.

### Example 4

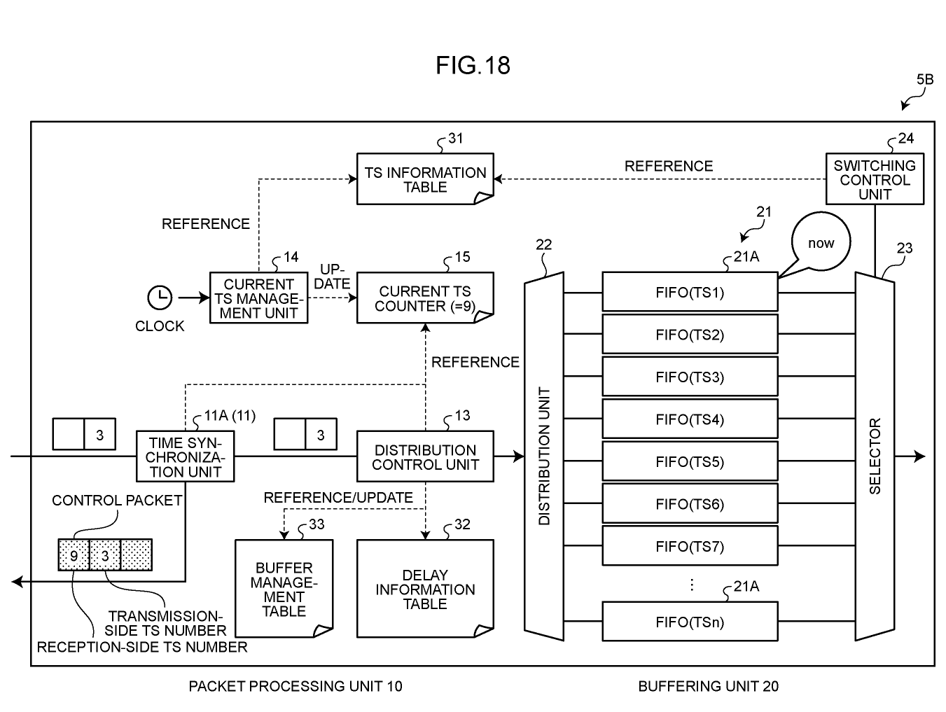

FIG. 16 is an explanatory diagram illustrating an example of a packet communication system 1B according to Example 4. Note that the same components as those of the packet communication system 1A of Example 2 are denoted by the same reference numerals, and the description of the overlapping components and operations will be omitted. The packet communication system 1B illustrated in FIG. 16 includes a transmission device 2, a reception device 3, a network 4, a transmission-side packet processing apparatus 6B, and a reception-side packet processing apparatus 5B.

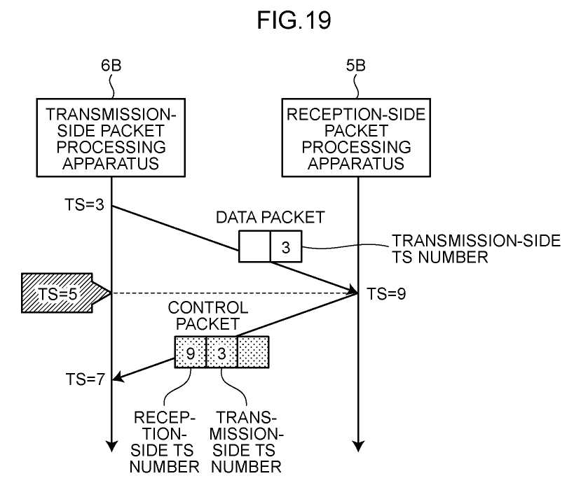

FIG. 17 is an explanatory diagram illustrating an example of the transmission-side packet processing apparatus 6B. The transmission-side packet processing apparatus 6B illustrated in FIG. 17 includes a current TS management unit 51, a current TS counter 52, a TS information table 54, a TS assignment unit 53, and a time synchronization unit 55. The time synchronization unit 55 synchronizes the current TS with the reception-side packet processing apparatus 5B by using the TS number of the control packet from the reception-side packet processing apparatus 5B.

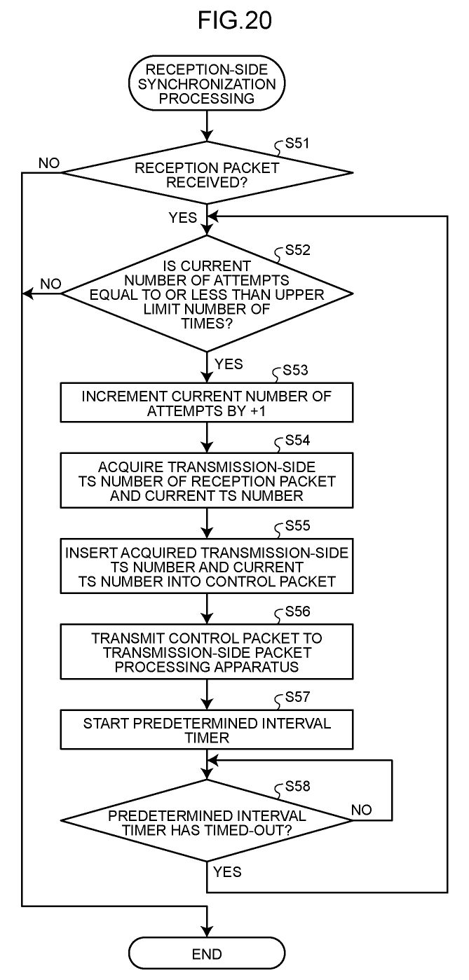

FIG. 18 is an explanatory diagram illustrating an example of the reception-side packet processing apparatus 5B. The packet processing unit 10 in the reception-side packet processing apparatus 5B illustrated in FIG. 18 includes a reception unit 11, a distribution control unit 13, a current TS management unit 14, and a current TS counter 15. The packet processing unit 10 includes a TS information table 31, a delay information table 32, and a buffer management table 33. The reception unit 11 includes a time synchronization unit 11A. The time synchronization unit 11A synchronizes the current TS with the transmission-side packet processing apparatus 6B by using the transmission-side TS number of the packet from the transmission-side packet processing apparatus 6B. The buffering unit 20 in the reception-side packet processing apparatus 5B includes a FIFO group 21, a distribution unit 22, a selector 23, and a switching control unit 24.

The time synchronization unit 11A stores the transmission-side TS number of the reception packet and the reception-side TS number which is the current TS number of the current TS counter 15 in the control packet, and transmits the control packet to the transmission-side packet processing apparatus. The time synchronization unit 55 in the transmission-side packet processing apparatus 6B calculates the TS difference based on the transmission-side TS number and the reception-side TS number in the control packet, and corrects the current TS based on the TS difference.

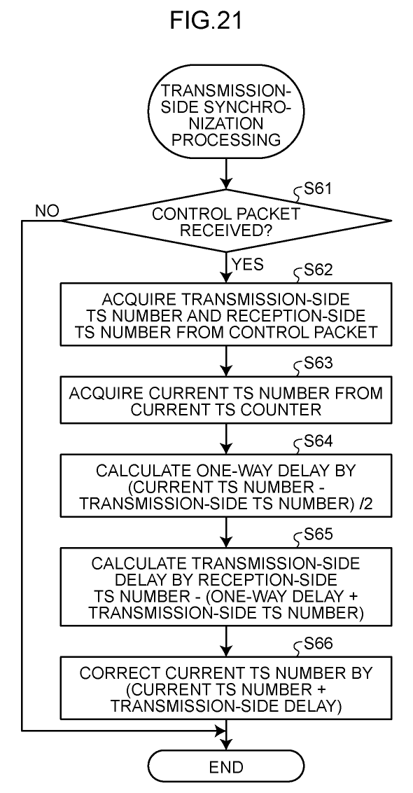

FIG. 19 is a sequence diagram illustrating an example of TS synchronization processing. In a case where the current TS number acquired by the current TS counter 52 is "3", the transmission-side packet processing apparatus 6B transmits the packet to which the transmission-side TS number "3" is assigned to the reception-side packet processing apparatus 5B.

In a case where the current TS number acquired by the current TS counter 15 is "9", the reception-side packet processing apparatus 5B transmits a control packet including the transmission-side TS number "3" in the reception packet and the reception-side TS number "9" to the transmission-side packet processing apparatus 6B.

When receiving the control packet, it is assumed that the transmission-side packet processing apparatus 6B acquires the current TS number "7" in the current TS counter 52. In this case, the round-trip delay is (7 - 3) = 4 TS. Therefore, the one-way delay is (4TS ÷ 2) = 2 TS. That is, the one-way delay between the transmission-side packet processing apparatus 6B and the reception-side packet processing apparatus 5B is 2 TS.

In a case where the TS number of the transmission-side packet processing apparatus 6B is "3" and 3 + 2 = 5, it can be estimated that the TS number of the reception-side packet processing apparatus 5B is "9". In this case, the transmission-side packet processing apparatus 6B can determine that the current TS on the transmission side is delayed by 4 TS as compared with the current TS on the reception side.

The time synchronization unit 55 in the transmission-side packet processing apparatus 6B can synchronize the current TS with the reception-side packet processing apparatus 5B by adding the current TS number + 4 TS. Note that since an error due to the influence of the delay or the like occurs when only one exchange is performed, the present synchronization processing may be executed a plurality of times, and the above calculation may be executed from the minimum value (the value having the least influence of the delay), and can be appropriately changed.

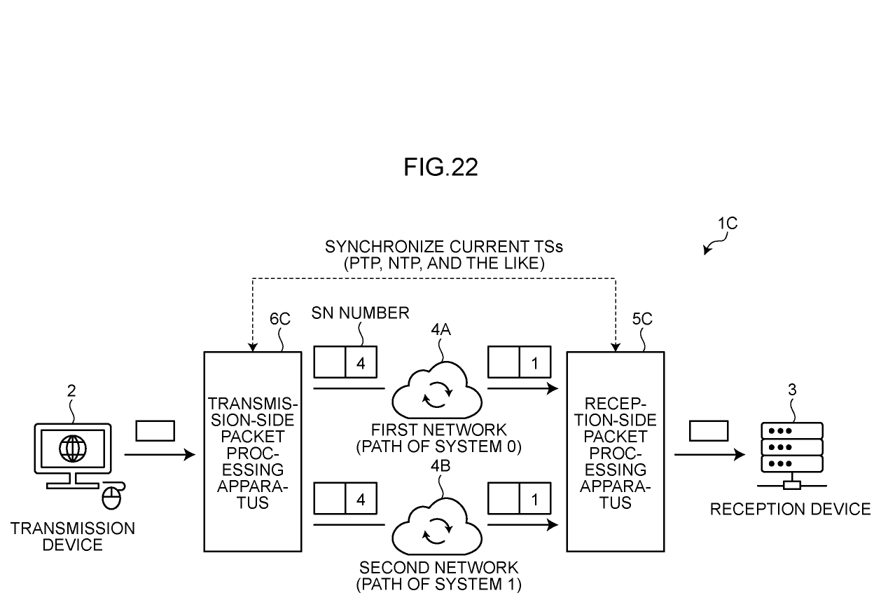

FIG. 20 is a flowchart illustrating an example of a processing operation of the reception-side packet processing apparatus 5B related to reception-side synchronization processing. In FIG. 20, the time synchronization unit 11A in the reception-side packet processing apparatus 5B determines whether a reception packet has been received from the transmission-side packet processing apparatus 6B (step S51). When the reception packet has been received (step S51: Yes), the time synchronization unit 11A determines whether the current number of attempts is equal to or less than the upper limit number of times (step S52).

In a case where the current number of attempts is equal to or smaller than the upper limit number of times (step S52: Yes), the time synchronization unit 11A increments the current number of attempts by +1 (step S53). The time synchronization unit 11A acquires the transmission-side TS number from the reception packet and acquires the current TS number from the current TS counter 15 (step S54).

After acquiring the transmission-side TS number and the current TS number, the time synchronization unit 11A inserts the transmission-side TS number and the current TS number into the control packet (step S55), and transmits the control packet to the transmission-side packet processing apparatus 6B (step S56). After transmitting the control packet, the time synchronization unit 11A starts the predetermined interval timer (step S57), and determines whether the predetermined interval timer has timed-out (step S58). When the predetermined interval timer has timed-out (step S58: Yes), the time synchronization unit 11A proceeds to the processing of step S52 of determining whether the current number of attempts is equal to or less than the upper limit number of times.

When the reception packet has not been received (step S51: No), the time synchronization unit 11A ends the processing operation illustrated in FIG. 20. In a case where the current number of attempts is not equal to or less than the upper limit number of times (step S52: No), the time synchronization unit 11A ends the processing operation illustrated in FIG. 20. Furthermore, when the predetermined interval timer has not timed-out (step S58: No), the time synchronization unit 11A proceeds to the processing of step S58 to determine whether the predetermined interval timer has timed-out.

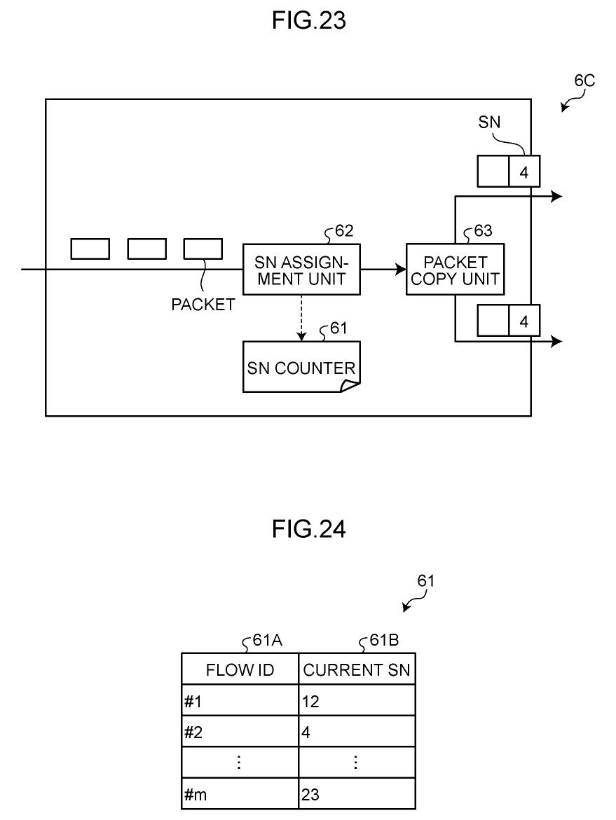

FIG. 21 is a flowchart illustrating an example of a processing operation of the transmission-side packet processing apparatus 6B related to transmission-side synchronization processing. In FIG. 21, the time synchronization unit 55 in the transmission-side packet processing apparatus 6B determines whether a control packet has been received from the reception-side packet processing apparatus 5B (step S61).

When the control packet has been received (step S61: Yes), the time synchronization unit 55 acquires the transmission-side TS number and the reception-side TS number from the control packet (step S62). In the example of FIG. 19, the transmission-side TS number is "3" and the reception-side TS number is "9". Further, the time synchronization unit 55 acquires the current TS number from the current TS counter 52 (step S63). In the example of FIG. 19, the current TS number is "7".

The time synchronization unit 55 calculates a one-way delay based on ((current TS number - transmission-side TS number) ÷ 2) (step S64). That is, the time synchronization unit 55 calculates a one-way delay 2TS based on ((7 - 3) ÷ 2). The time synchronization unit 55 calculates a transmission-side delay based on (reception-side TS number - (one-way delay + transmission-side TS number)) (step S65). That is, the time synchronization unit 55 calculates a transmission-side delay 4TS based on (9 - (2 + 3)).

The time synchronization unit 55 adds the transmission-side delay to the next current TS number to perform time synchronization (step S66), and ends the processing operation illustrated in FIG. 21. Then, the time synchronization unit 55 adds the transmission-side delay 4TS to the current TS number to synchronize with the current TS of the reception-side packet processing apparatus 5B.

In a case where the control packet has not been received (step S61: No), the time synchronization unit 55 ends the processing operation illustrated in FIG. 21.

When transmitting a packet to the reception-side packet processing apparatus 5B, the transmission-side packet processing apparatus 6B of Example 4 transmits a packet including a transmission-side TS number which is a current TS number to the reception-side packet processing apparatus 5B. When receiving the packet from the transmission-side packet processing apparatus 6B, the reception-side packet processing apparatus 5B extracts the transmission-side TS number from the packet and acquires the reception-side TS number as the current TS number. The reception-side packet processing apparatus 5B transmits a control packet including the transmission-side TS number and the reception-side TS number to the transmission-side packet processing apparatus 6B. When receiving the control packet, the transmission-side packet processing apparatus 6B extracts the current TS number and extracts the transmission-side TS number and the reception-side TS number in the control packet. The transmission-side packet processing apparatus 6B corrects the current TS number counted by the transmission-side packet processing apparatus 6B based on the transmission-side TS number, the reception-side TS number, and the current TS number. As a result, TS synchronization between the transmission-side packet processing apparatus 6B and the reception-side packet processing apparatus 5B can be secured without using an external synchronization unit.

Note that, in the packet communication system 1A of Example 2, a case where a packet is transmitted between the transmission-side packet processing apparatus 6A and the reception-side packet processing apparatus 5A via the network 4 has been illustrated. However, an embodiment of a redundant configuration in which packets are transmitted between the transmission-side packet processing apparatus 6A and the reception-side packet processing apparatus 5A via the path of a system 0 of a first network 4A and the path of a system 1 of a second network 4B will be described below as Example 5. Note that the same components as those of the packet communication system 1A of Example 2 are denoted by the same reference numerals, and the description of the overlapping components and operations will be omitted.

### Example 5

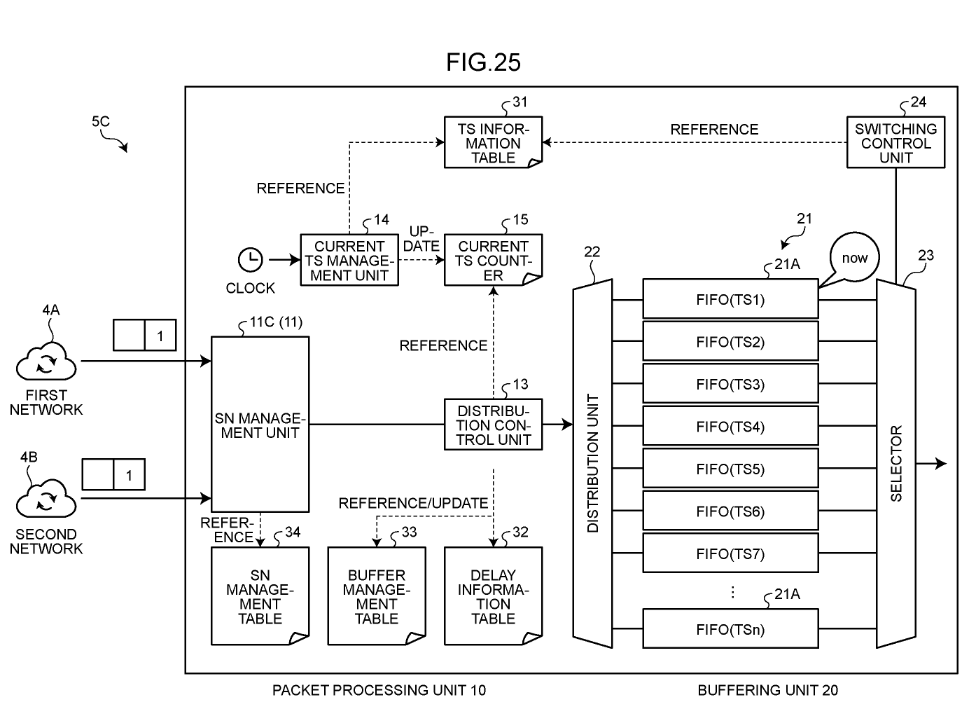

FIG. 22 is an explanatory diagram illustrating an example of a packet communication system 1C according to Example 5. The packet communication system 1C illustrated in FIG. 22 includes a transmission device 2, a reception device 3, a transmission-side packet processing apparatus 6C, a reception-side packet processing apparatus 5C, a first network 4A, and a second network 4B.

The transmission-side packet processing apparatus 6C is connected to the reception-side packet processing apparatus 5C via the path of a system 0 of the first network 4A, and is connected to the reception-side packet processing apparatus 5C via the path of a system 1 of the second network 4B different from the first network 4A.

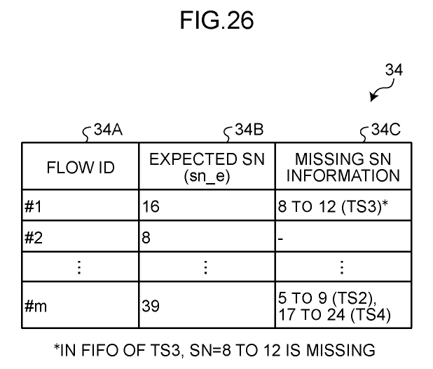

FIG. 23 is an explanatory diagram illustrating an example of the transmission-side packet processing apparatus 6C. The transmission-side packet processing apparatus 6C illustrated in FIG. 23 includes an SN (Sequence Number) counter 61, an SN assignment unit 62, and a packet copy unit 63. The SN counter 61 counts SNs for identifying consecutive numbers of packets of the same flow. When transmitting a packet to the reception-side packet processing apparatus 5C, the SN assignment unit 62 assigns an SN to the packet. The packet copy unit 63 copies the packet to which the SN is assigned, transmits the packet via the path of the system 0 of the first network 4A and transmits the packet via the path of the system 1 of the second network 4B. The reception-side packet processing apparatus 5C can recognize that the packets are the same packet based on the flow ID and the SN in the packet received via the path of the system 0 of the first network 4A and the flow ID and the SN in the packet received via the path of the system 1 of the second network 4B.

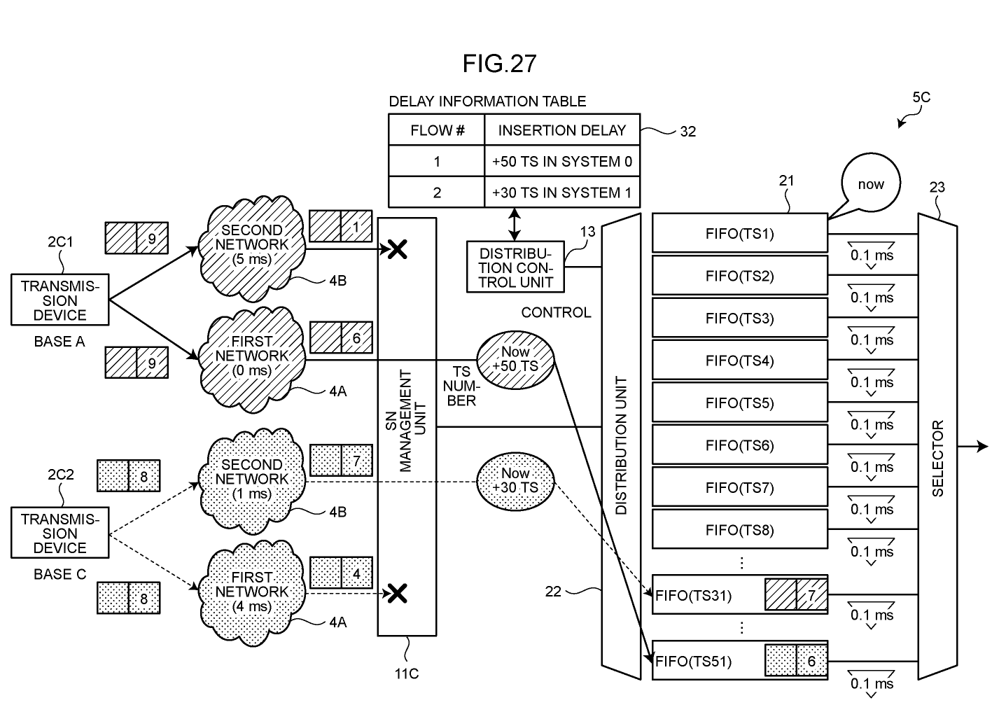

FIG. 24 is an explanatory diagram illustrating an example of a table configuration of an SN counter 61. The SN counter 61 illustrated in FIG. 24 manages the current SN 61B for each flow ID 61A. The SN assignment unit 62 refers to the current SN 61B corresponding to the flow ID 61A in the SN counter 61, and assigns the SN to the packet.

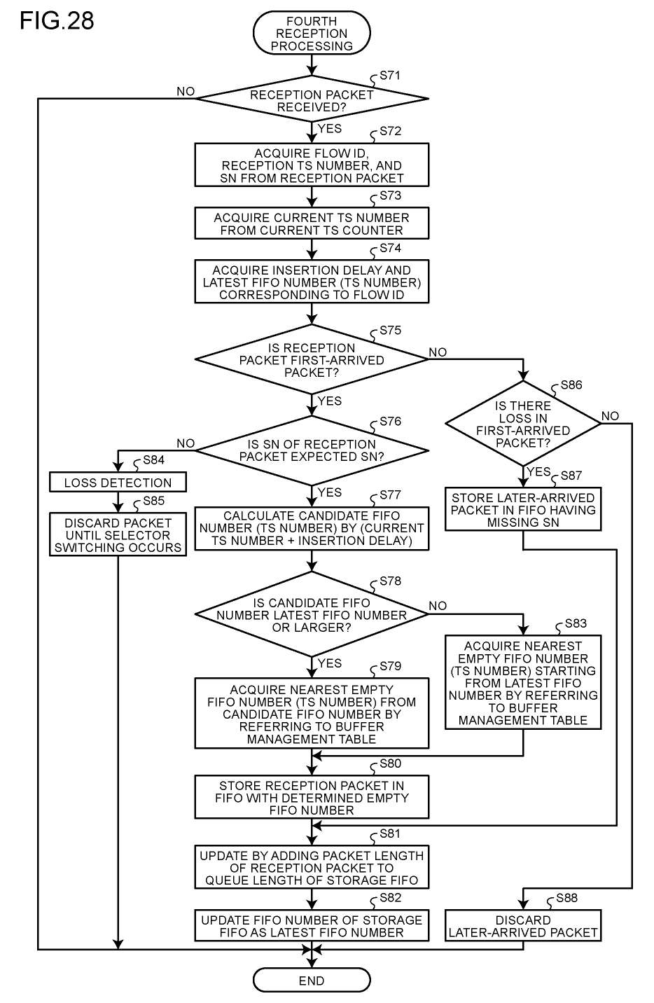

FIG. 25 is an explanatory diagram illustrating an example of the reception-side packet processing apparatus 5C. The packet processing unit 10 in the reception-side packet processing apparatus 5C illustrated in FIG. 25 includes an SN management unit 11C of the reception unit 11, a distribution control unit 13, a current TS management unit 14, and a current TS counter 15. The packet processing unit 10 includes a TS information table 31, a delay information table 32, a buffer management table 33, and an SN management table 34. The SN management unit 11C acquires the flow ID and the SN of the first reception packet when the first reception packet has been received from the path of the system 0 of the first network 4A. Further, the SN management unit 11C acquires the flow ID and the SN of the second reception packet when the second reception packet has been received from the path of the system 1 of the second network 4B. Among the same packets received from the path of the system 0 and the path of the system 1, the SN management unit 11C identifies a first-arrived packet received earlier and a later-arrived packet received later compared to the first-arrived packet.

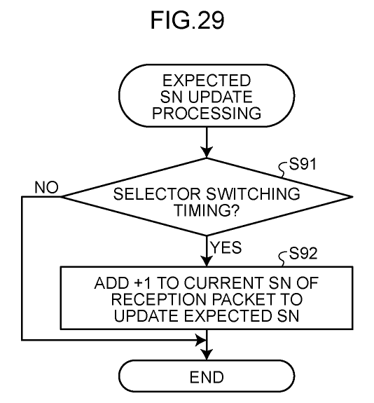

FIG. 26 is an explanatory diagram illustrating an example of a table configuration of an SN management table 34. The SN management table 34 illustrated in FIG. 26 manages the expected SN 34B and the missing SN information 34C for each flow ID 34A. The expected SN 34B is an SN of a packet to be received next. The missing SN information 34C includes an SN in a state in which a first-arrived packet is missing and a FIFO number of the FIFO 21A in which the first-arrived packet is supposed to be stored. The SN management unit 11C refers to the SN management table 34 and recognizes the expected SN and the missing SN for each flow ID 34A. In the case of the flow ID of #1, the SN management unit 11C recognizes the FIFO numbers of the expected SN "16", the missing SN "8 to 12", and "TS3". With reference to the SN management table 34, the SN management unit 11C can recognize an SN expected to be received next, an SN whose first-arrived packet of the same SN is missing and which needs to be complemented with a later-arrived packet of the same SN, and information of a FIFO number for buffering the packet.

The SN management unit 11C in the reception unit 11 measures a packet delay difference of the same SN between the path of the system 0 via the first network 4A and the path of the system 1 via the second network 4B for each flow ID identified by the VLAN ID or the like. When the sampling number of the delay difference reaches a predetermined sampling number, the SN management unit 11C calculates the delay difference of the flow by adding a predetermined margin to the maximum delay difference among the delay differences of the predetermined sampling number. For example, the delay difference with the predetermined sampling number of 100 is within the range of 4.2 to 4.8 msec, in the SN management unit 11C, the insertion delay that is the delay difference of the flow becomes 5 msec that is obtained by adding a predetermined margin, for example, 0.2 msec to the maximum delay difference of 4.8 msec.

Then, the SN management unit 11C converts a delay difference obtained for each flow into a TS unit, and calculates a TS-converted delay difference of the flow as an insertion delay. Specifically, when 1 TS = 0.1 msec and the delay difference of the flow is 5 msec, the insertion delay that is the TS-converted delay difference is 50 TS. Then, the SN management unit 11C calculates an insertion delay which is a TS-converted delay difference of the flow, and stores the calculated insertion delay in the delay information table 32 for each flow ID for identifying the flow.

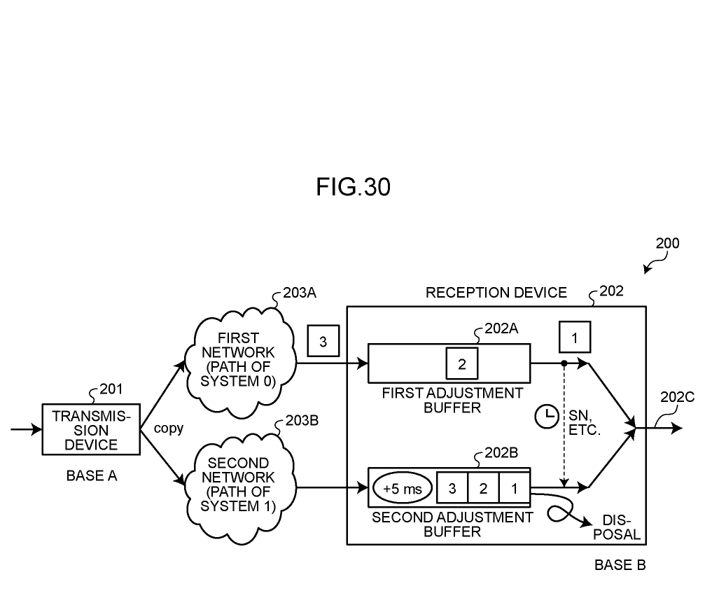

FIG. 27 is an explanatory diagram illustrating an example of a buffering operation of the reception-side packet processing apparatus 5C. The reception-side packet processing apparatus 5C in the base B is connected to the path of the system 0 of the first network 4A and the path of the system 1 of the second network 4B with the transmission-side packet processing apparatus 6C in a transmission device 2C1 in the base A. In addition, the reception-side packet processing apparatus 5C is connected to the path of the system 0 of the first network 4A and the path of the system 1 of the second network 4B with the transmission-side packet processing apparatus 6C in a transmission device 2C2 in the base C.

It is assumed that the reception-side packet processing apparatus 5C receives the packet of the flow #1 from the transmission device 2C1 of the base A in 0 msec when the path of the system 0 is used and receives the packet of the flow #1 from the transmission device 2C1 of the base A in 5 msec when the path of the system 1 is used. That is, among the packets from the transmission device 2C1 in the base A, the packet from the path of the system 0 is a first-arrived packet, and the packet from the path of the system 1 is a later-arrived packet. The packet delay of the flow #1 with the transmission device 2C1 in the base A is 5 msec in the path of the system 1 as compared with the path of the system 0. For example, when 1 TS = 0.1 msec, the delay difference of flow #1 for 5 msec is 50 TS. Then, in the delay information table 32, for example, "+50 TS delay in the path of system 0" is stored as the insertion delay of the flow #1.

It is assumed that the reception-side packet processing apparatus 5C receives the packet of the flow #2 from the transmission device 2C2 of the base C in 4 msec when the path of the system 0 is used and receives the packet of the flow #2 from the transmission device 2C2 of the base C in 1 msec when the path of the system 1 is used. That is, among the packets from the transmission device 2C2 in the base C, the packet from the path of the system 0 is a later-arrived packet, and the packet from the path of the system 1 is a first-arrived packet. The packet delay of the flow #2 with the transmission device 2C2 in the base C is 3 msec in the path of the system 0 as compared with the path of the system 1. That is, the delay difference of flow #2 for 3 msec is 30 TS. Then, in the delay information table 32, for example, "+30 TS delay in the path of system 1" is stored as the insertion delay of the flow #2.

When the first-arrived packet of the flow #1 arrives from the path of the system 0 and the current TS number is TS1, the distribution control unit 13 refers to the insertion delay of the flow #1 in the delay information table 32 and calculates TS1 + 50 TS = TS51 as the TS number corresponding to the FIFO number of the distribution destination. The distribution control unit 13 controls the distribution unit 22 to distribute the first-arrived packet of the flow #1 to the empty FIFO 21A corresponding to the calculated FIFO number of TS51.

In addition, when the first-arrived packet of the flow #2 arrives from the path of the system 1, the distribution control unit 13 refers to the insertion delay of the flow #2 in the delay information table 32 and calculates TS1 + 30 TS = TS31 as the TS number corresponding to the FIFO number of the distribution destination. The distribution control unit 13 controls the distribution unit 22 to distribute the first-arrived packet of the flow #2 to the empty FIFO 21A corresponding to the calculated FIFO number of TS31.

The switching control unit 24 controls the selector 23 so as to sequentially switch the FIFO 21A to be read among the plurality of FIFOs 21A to which the TS number is assigned in order of the TS number at a predetermined time TS, for example, every 1 msec.

The distribution control unit 13 refers to the delay information table 32 and distributes the reception packet of the flow to the empty FIFO 21A having the FIFO number corresponding to the insertion delay of the flow among the plurality of FIFOs 21A.

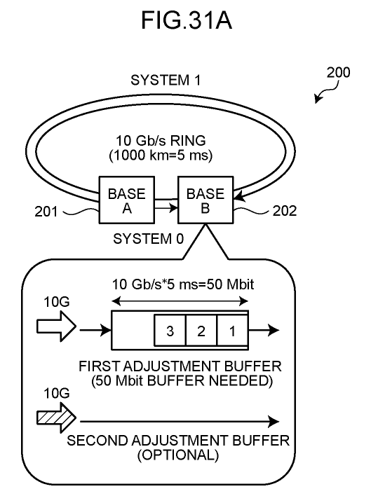

FIG. 28 is a flowchart illustrating an example of a processing operation of the reception-side packet processing apparatus 5C related to fourth reception processing. In FIG. 28, the SN management unit 11C in the reception unit 11 in the reception-side packet processing apparatus 5C determines whether a reception packet has been received (step S71). When the reception packet has been received (step S71: Yes), the SN management unit 11C acquires the flow ID, the reception TS number, and SN from the reception packet (step S72).

Further, the distribution control unit 13 acquires the current TS number from the current TS counter 15 (step S73). The distribution control unit 13 refers to the delay information table 32 and acquires the insertion delay 32B and the latest FIFO number 32C corresponding to the flow ID 32A (step S74). The distribution control unit 13 determines whether the reception packet is a first-arrived packet (step S75).

When the received packet is a first-arrived packet (step S75: Yes), the distribution control unit 13 determines whether the SN of the reception packet is an expected SN (step S76). When the SN of the reception packet is the expected SN (step S76: Yes), the distribution control unit 13 calculates a FIFO number corresponding to a TS number corresponding to (current TS number + insertion delay) as a candidate FIFO number (step S77). The distribution control unit 13 determines whether the calculated candidate FIFO number is equal to or larger than the latest FIFO number (step S78).

When the candidate FIFO number is equal to or larger than the latest FIFO number (step S78: Yes), the distribution control unit 13 refers to the buffer management table 33 and acquires the FIFO number of the nearest empty FIFO 21A from the candidate FIFO number (step S79). The distribution control unit 13 stores the reception packet in the empty FIFO 21A corresponding to the acquired FIFO number (step S80). Further, the distribution control unit 13 adds the packet length of the reception packet to the queue length of the FIFO 21A storing the reception packet and updates the content of the buffer management table 33 (step S81). Further, the distribution control unit 13 updates the content of the delay information table 32 with the FIFO number of the FIFO 21A storing the reception packet as the latest FIFO number (step S82), and ends the processing operation illustrated in FIG. 28.

When the candidate FIFO number is not equal to or larger than the latest FIFO number (step S78: No), the distribution control unit 13 refers to the buffer management table 33. Then, the distribution control unit 13 acquires the FIFO number of the nearest empty FIFO 21A starting from the latest FIFO number (step S83), and proceeds to the processing of step S80.

In a case where the reception packet has not been received (step S71: No), the distribution control unit 13 ends the processing operation illustrated in FIG. 28.

When the reception packet is not a first-arrived packet (step S75: No), the distribution control unit 13 determines that the reception packet is a later-arrived packet and determines whether there is a loss in the first-arrived packet (step S86). In a case where there is a loss in the first-arrived packet (step S86: Yes), the distribution control unit 13 stores the later-arrived packet in the FIFO 21A having the missing SN (step S87), and proceeds to the processing of step S81.

In a case where there is no loss in the first-arrived packet (step S86: No), the distribution control unit 13 discards the later-arrived packet (step S88), and ends the processing operation illustrated in FIG. 28.

Further, in a case where the SN of the reception packet is not the expected SN (step S76: No), the distribution control unit 13 determines that the reception packet is missing (packet loss) (step S84). Then, the distribution control unit 13 discards the reception packet until the next switching timing of the selector 23 (step S85), and ends the processing operation illustrated in FIG. 28.

In a case where the reception packet is a first-arrived packet and the SN of the received packet is the expected SN, the distribution control unit 13 calculates the candidate FIFO number by (current TS number + insertion delay). The distribution control unit 13 determines whether the candidate FIFO number is equal to or larger than the latest FIFO number. In a case where the candidate FIFO number is equal to or larger than the latest FIFO number, the distribution control unit 13 determines the nearest empty FIFO number from the candidate FIFO numbers. As a result, the FIFO 21A as the first-arrived packet distribution destination can be determined.

In a case where the candidate FIFO number is not equal to or larger than the latest FIFO number, the distribution control unit 13 determines the nearest empty FIFO number starting from the latest FIFO number. As a result, the FIFO 21A as the first-arrived packet distribution destination can be determined.

In a case where the reception packet is a later-arrived packet and there is a loss in the first-arrived packet, the distribution control unit 13 stores the later-arrived packet in the FIFO 21A having the missing SN. As a result, even when the loss occurs in the first-arrived packet, the packet can be complemented with the later-arrived packet.

In a case where the reception packet is a later-arrived packet and there is no loss in the first-arrived packet, the distribution control unit 13 discards the later-arrived packet. As a result, storage of duplicate packets can be reduced.

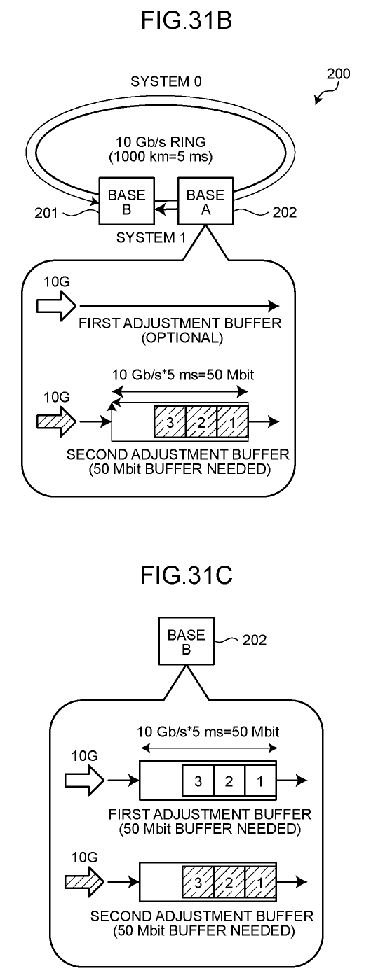

FIG. 29 is a flowchart illustrating an example of a processing operation of the reception-side packet processing apparatus 5C related to the expected SN update processing. The SN management unit 11C in the reception-side packet processing apparatus 5C determines whether it is the switching timing of the selector 23 at present (step S91). When it is the switching timing at present (step S91: Yes), the SN management unit 11C increments the current SN of the reception packet by +1 to update the expected SN in the SN management table 34 (step S92), and ends the processing operation illustrated in FIG. 29.

When it is not the switching timing at present (step S91: No), the SN management unit 11C ends the processing operation illustrated in FIG. 29.

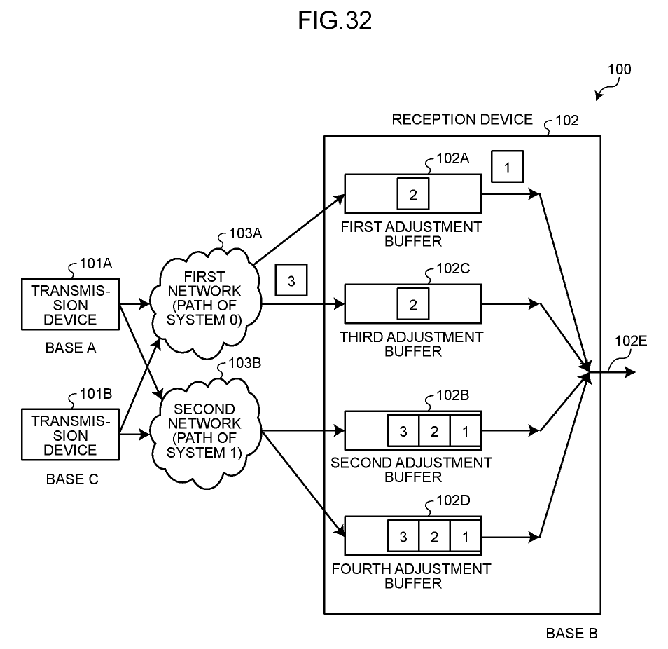

Here, in order to compare with the packet communication system 1C of Example 5, a packet communication system 200 of Comparative Example 1 and a packet communication system 100 of Comparative Example 2 will be described. FIG. 30 is an explanatory diagram illustrating an example of the packet communication system 200 according to Comparative Example 1. The packet communication system 200 illustrated in FIG. 30 includes a transmission device 201 in the base A, a reception device 202 in the base B, a first network 203A, and a second network 203B. The first network 203A and the second network 203B are prepared for redundancy between the transmission device 201 and the reception device 202. The transmission device 201 copies the packet, transmits the packet to the reception device 202 via the first network 203A, and transmits the packet to the reception device 202 via the second network 203B.

The reception device 202 includes a first adjustment buffer 202A, a second adjustment buffer 202B, and a selector 202C. The first adjustment buffer 202A is a delay adjustment buffer that is connected to the first network 203A and buffers a reception packet from the first network 203A. The second adjustment buffer 202B is a delay adjustment buffer that is connected to the second network 203B and buffers a reception packet from the second network 203B. The selector 202C selects and outputs a reception packet from the adjustment buffer of the first adjustment buffer 202A and the second adjustment buffer 202B.

The transmission device 201 copies the packet and transmits the packet to the reception device 202 using, for example, the first network 203A and the second network 203B. Then, the reception device 202 selects one packet from the packets respectively received by the first network 203A and the second network 203B. In addition, in order to fill the delay difference between the first network 203A and the second network 203B, the reception device 202 adjusts the delay in units of paths by holding the packet received on the path on which the packet arrives first for the delay period.

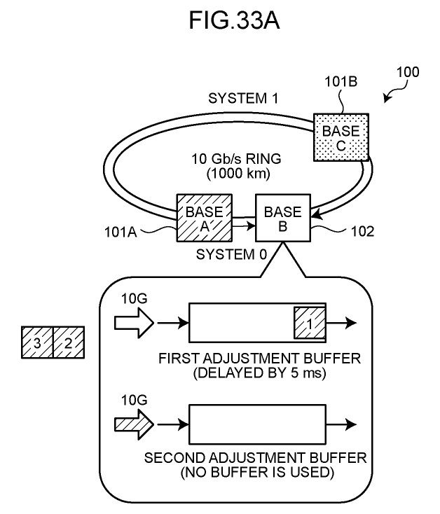

FIGS. 31A, 31B and 31C are explanatory diagrams illustrating an example of a buffering state of Comparative Example 1. In the packet communication system 200 of Comparative Example 1, the first adjustment buffer 202A and the second adjustment buffer 202B are prepared for each base, and the memory amount of the adjustment buffer used for delay adjustment increases. However, at the base, since it is not known which path of the system 0 or 1 arrives first, an adjustment buffer is needed for the paths of both systems.

For example, a case is assumed in which it is desired to absorb a delay difference of up to 1000 km (5 msec) between the path of the system 0 and the path of the system 1 between the transmission device 201 and the reception device 202 with a ring of 10 giga bps.

In the reception device 202, as illustrated in FIG. 31A, for example, in a case where the path of the system 0 is approximately 0 km, the path of the system 1 is approximately 1000 km, and packets of the path of the system 0 arrive first, the second adjustment buffer 202B connected to the path of the system 1 can omit a buffer. However, the first adjustment buffer 202A connected to the path of the system 0 requires a 50 megabit buffer.

In addition, in the reception device 202, as illustrated in FIG. 31B, for example, in a case where the path of the system 1 is approximately 0 km, the path of the system 0 is approximately 1000 km, and packets of the path of the system 1 arrive first, the first adjustment buffer 202A connected to the path of the system 0 can omit a buffer. However, the second adjustment buffer 202B connected to the path of the system 1 requires a 50 Mbit buffer.

That is, in the packet communication system 200, since it is not known which packet of the path of the system 0 or the path of the system 1 arrives first depending on the positional relationship between the transmission device 201 and the reception device 202, the reception device 202 needs the adjustment buffer of 50 Mbits for both systems 0 and 1.

On the other hand, in the reception-side packet processing apparatus 5C of Example 5, in a case where a first-arrived packet is stored in the FIFO 21A, the distribution control unit 13 in the preceding stage of the FIFO 21A discards a later-arrived packet. As a result, since only one packet of the path of the system 0 and the path of the system 1 is buffered, the FIFO 21A can be shared by the path of the system 0 and the path of the system 1.

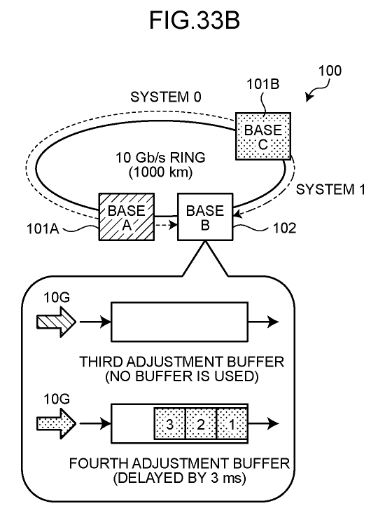

FIG. 32 is an explanatory diagram illustrating an example of the packet communication system 100 according to Comparative Example 2. The packet communication system 100 illustrated in FIG. 32 includes a transmission device 101A in the base A, a transmission device 101B in the base C, a reception device 102 in the base B, a first network 103A, and a second network 103B.

The reception device 102 includes a first adjustment buffer 102A, a second adjustment buffer 102B, a third adjustment buffer 102C, a fourth adjustment buffer 102D, and a selector 102E. The first adjustment buffer 102A is a delay adjustment buffer that is connected to the first network 103A and buffers a reception packet from the first network 103A. The second adjustment buffer 102B is a delay adjustment buffer that is connected to the second network 103B and buffers a reception packet from the second network 103B. The third adjustment buffer 102C is a delay adjustment buffer that is connected to the first network 103A and buffers a reception packet from the first network 103A. The fourth adjustment buffer 102D is a delay adjustment buffer that is connected to the second network 103B and buffers a reception packet from the second network 103B. The selector 102E selects and outputs a reception packet from the adjustment buffer among the first adjustment buffer 102A, the second adjustment buffer 102B, the third adjustment buffer 102C, and the fourth adjustment buffer 102D.

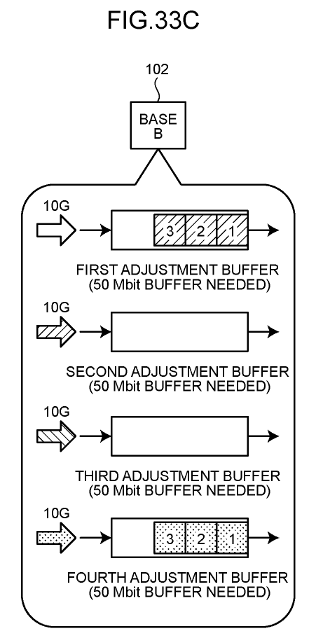

FIGS. 33A, 33B and 33C are explanatory diagrams illustrating an example of a buffering state of Comparative Example 2. The first transmission time until the reception device 102 in the base B receives the reception packet from the transmission device 101A in the base A via the first network 103A is 8 msec. In addition, the second transmission time until the reception device 102 in the base B receives the reception packet from the transmission device 101B in the base C via the second network 103B is 3 msec.

As illustrated in FIG. 33A, for example, between the transmission device 101A of the base A and the reception device 102 of the base B, the path of the system 0 of the first network 103A is about 0 km (0 msec), and the path of the system 1 of the second network 103B is about 1000 km (5 msec). In the reception device 102 in the base B, the first adjustment buffer 102A is not used, and the delay of 5 msec is introduced by the second adjustment buffer 102B.

As illustrated in FIG. 33B, for example, between the transmission device 101 of the base C and the reception device 102 of the base B, the path of the system 0 of the first network 103A is about 800 km (4 msec), and the path of the system 1 of the second network 103B is about 200 km (1 msec). In the reception device 102 in the base B, the third adjustment buffer 102C is not used, and the delay of 3 msec is introduced by the fourth adjustment buffer 102D.

As illustrated in FIG. 33C, in the reception device 102 of the base B, between the path from the base A to the base B and the path from the base C to the base B, the paths to be queued and the delay adjustment times are different respectively, and thus, it is needed to prepare the delay adjustment buffer for each base. Moreover, in the reception device 102 in the base B, instantaneous traffic of up to 10 Gbps may arrive on any path, and thus 50-megabit adjustment buffer is needed for each path. That is, in the packet communication system 100, since the delay amount differs for each base, the adjustment buffer is not able to be shared between the bases, and the adjustment buffer is needed for each base.

On the other hand, in the reception-side packet processing apparatus 5C of Example 5, it is only needed to distribute the first-arrived packet to the FIFO 21A with the FIFO number reflecting the insertion delay. As a result, the FIFO 21A of the transmission devices 2 in all the bases can be shared without providing the FIFO 21A for each base.

The reception-side packet processing apparatus 5C of Example 5 manages an insertion delay according to a packet delay difference between the first network 4A and the second network 4B paths when receiving packets of the same SN from the first network 4A and the second network 4B, respectively. When receiving packets of the same SN from the first network 4A or the second network 4B, the distribution control unit 13 calculates the TS number (FIFO number) of the distribution destination according to the insertion delay of the flow to which the packet belongs. The distribution control unit 13 determines the FIFO 21A of the calculated FIFO number of the distribution destination as the distribution destination FIFO 21A from the FIFO group 21. The distribution unit 22 distributes first-arrived packets among the packets received from the first network 4A and the second network 4B to the distribution destination FIFO 21A. As a result, the jitter and the delay can be adjusted while sharing the FIFO 21A in all the bases as a matter of course in the path of the system 0 and the path of the system 1. As compared with Comparative Examples 1 and 2, significant reduction due to sharing of the FIFO 21A becomes possible.

The distribution control unit 13 calculates the FIFO number of the distribution destination based on the TS number and the SN of each received packet and the insertion delay of the flow ID according to the packet delay difference between the first network 4A and the second network 4B. Based on the calculated FIFO number of the distribution destination, the distribution control unit 13 distributes first-arrived packets of the same flow ID, the same TS number, and the same SN to the distribution destination FIFO 21A. As a result, first-arrived packets of the same SN can be distributed from the shared FIFO group 21.

When receiving a later-arrived packet of the same flow ID, the same TS number, and the same SN after storing the first-arrived packets of the same flow ID, the same TS number, and the same SN in the distribution destination FIFO 21A, the distribution control unit 13 discards the later-arrived packet. As a result, FIFO storage of duplicate packets can be reduced.

It is assumed that the distribution control unit 13 receives a later-arrived packet of the same flow ID, the same TS number, and the same SN in a state in which a first-arrived packet of the same flow ID, the same TS number, and the same SN is missing. In this case, based on the calculated FIFO number of the distribution destination, the distribution control unit 13 distributes later-arrived packet to the distribution destination FIFO 21A. As a result, even when the first-arrived packet is missing, the packet can be complemented with the later-arrived packet.

Note that the packet processing apparatus 5 of the present embodiment can be applied to, for example, a relay device that performs packet processing such as an Ethernet switch or a router, a terminal device that transmits and receives packets such as a PC or a server, or the like.

In the above embodiment, the distribution control unit 13, the current TS counter 15, and the current TS management unit 14 are arranged in the packet processing unit 10. However, for example, the distribution control unit 13, the current TS counter 15, and the current TS management unit 14 may be arranged inside an FPGA or a CPU (not illustrated), and can be appropriately changed.

In addition, each component of each unit illustrated in the drawings is not necessarily physically configured as illustrated in the drawings. That is, a specific form of distribution and integration of each unit is not limited to the illustrated form, and all or a part thereof can be functionally or physically distributed and integrated in an arbitrary unit according to various loads, usage conditions, and the like.

Furthermore, all or any part of various processing functions performed in each device may be executed on a central processing unit (CPU) (or a micro computer such as a micro processing unit (MPU) or a micro controller unit (MCU)). In addition, it goes without saying that all or any part of the various processing functions may be executed on a program analyzed and executed by a CPU (or a micro computer such as an MPU or an MCU) or on hardware by wired logic.

Furthermore, the various processes described in the present embodiment can be achieved by causing a processor such as a CPU in the information processing apparatus to execute a program prepared in advance.

In one aspect, delay and jitter can be adjusted.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A packet processing apparatus comprising a packet processor that processes a received packet and a buffering storage that performs storage processing on the received packet, wherein
the buffering storage includes:
a plurality of buffers that each stores the received packet;
a selector that selects the buffer from which the packet is output; and
a switching controller that controls the selector to sequentially switch buffers to be read from the plurality of buffers, and
the packet processor includes a distribution controller that determines a buffer of a distribution destination based on an insertion delay amount of each flow to which the packet belongs when the packet is received.

2. The packet processing apparatus according to claim 1, wherein the switching controller controls the selector at a constant cycle to sequentially switch the buffer, and
the distribution controller further determines the buffer of the distribution destination based on the constant cycle of the selector.

3. The packet processing apparatus according to claim 1, wherein the distribution controller distributes to a buffer corresponding to a timing at which the time selected and read by the selector is delayed by an insertion delay amount for each flow.

4. The packet processing apparatus according to claim 1, wherein the distribution controller extracts information related to time in the received packet, and determines the buffer of the distribution destination according to the extracted information related to time and the insertion delay amount.

5. The packet processing apparatus according to claim 1, wherein the distribution controller extracts information related to time in the received packet, and determines the buffer of the distribution destination according to the extracted information related to time, the insertion delay amount, and the number of buffers.

6. The packet processing apparatus according to claim 1, wherein the packet processor includes a manager that is connected to a first path for transmitting the packet from an opposing device and a second path different from the first path and acquires flow identification information, information related to time, and a sequence number of the packet received from the first path and the second path, respectively, and
the distribution controller determines the buffer of the distribution destination based on information related to time of packets respectively received from the first path and the second path and having the same sequence number, and an insertion delay amount of the flow identification information according to a packet delay difference between the first path and the second path.

7. The packet processing apparatus according to claim 1, wherein the buffer is a FIFO that stores the packet.

8. The packet processing apparatus according to claim 6, wherein the distribution controller distributes, among the packets respectively received from the first path and the second path, a first-arrived packet having the same flow identification information, the same information related to time, and the same sequence number to the buffer of the distribution destination based on the determined buffer of the distribution destination.

9. The packet processing apparatus according to claim 8, wherein, when a later-arrived packet having the same flow identification information, the same information related to time, and the same sequence number is received among the packets respectively received from the first path and the second path after the first-arrived packet is stored in the buffer of the distribution destination, the distribution controller discards the later-arrived packet.

10. The packet processing apparatus according to claim 8, wherein, when a later-arrived packet having the same flow identification information, the same information related to time, and the same sequence number is received among the packets respectively received from the first path and the second path in a state where the first-arrived packet is missing, the distribution controller distributes the later-arrived packet to the buffer of the distribution destination based on the determined buffer of the distribution destination.

11. A packet communication system comprising a transmission-side packet processing apparatus connected to a transmission device and a reception-side packet processing apparatus connected to a reception device, wherein the reception-side packet processing apparatus includes:
a packet processor that processes a packet received from the transmission-side packet processing apparatus; and a buffering storage that performs storage processing on the received packet,
the buffering storage includes:
a plurality of buffers that each stores the received packet;
a selector that selects the buffer from which the packet is output; and
a switching controller that controls the selector to sequentially switch buffers to be read from the plurality of buffers, and
the packet processor includes a distribution controller that determines a buffer of a distribution destination based on an insertion delay amount of each flow to which the packet belongs when the packet is received.

12. The packet communication system according to claim 11, wherein, after synchronizing current information related to time between the transmission-side packet processing apparatus and the reception-side packet processing apparatus, the transmission-side packet processing apparatus transmits the packet including current first information related to time when transmitting the packet to the reception-side packet processing apparatus, and
the reception-side packet processing apparatus corrects current second information related to time counted by the reception-side packet processing apparatus based on the first information related to time in the packet when the packet is received from the transmission-side packet processing apparatus.

13. The packet communication system according to claim 12, wherein the transmission-side packet processing apparatus transmits the packet including current first information related to time to the reception-side packet processing apparatus when transmitting the packet to the reception-side packet processing apparatus,
the reception-side packet processing apparatus:
extracts the first information related to time from the packet and acquires current second information related to time when the packet is received from the transmission-side packet processing apparatus, and
transmits a control packet including the first information related to time and the second information related to time to the transmission-side packet processing apparatus, and
the transmission-side packet processing apparatus:
acquires current third information related to time when the control packet is received, and extracts the first information related to time and the second information related to time in the control packet, and
corrects the current information related to time counted by the transmission-side packet processing apparatus based on the first information related to time, the second information related to time, and the third information related to time.

14. A packet processing circuit in a packet processing apparatus comprising a buffering storage including a plurality of buffers that each stores the received packet, a selector that selects the buffer from which the packet is output, and a switching controller that controls the selector to sequentially switch buffers to be read from the plurality of buffers, wherein the packet processing circuit includes a distribution controller that determines a buffer of a distribution destination based on an insertion delay amount of each flow to which the packet belongs when the packet is received.
